(19) United States
(12) Patent Application Publication
(10) Pub. No.: US 2025/0215743 A1
(43) Pub. Date: Jul. 3, 2025

(54) SLIDING FENESTRATION UNIT WITH WATER MANAGEMENT

(71) Applicant: Pella Corporation, Pella, IA (US)

(72) Inventors: Jeffrey W. Shelton, Oskaloosa, IA (US); Jonathan S. Hoogland, Atoona, IA (US); Howard C. Anderson, III, Tracy, IA (US); Joseph Allen Ritzert, Pella, IA (US); Todd M. Leathers, Pella, IA (US); Shelby C. Clair, Pella, IA (US)

(73) Assignee: Pella Corporation, Pella, IA (US)

(21) Appl. No.: 18/849,982

(22) PCT Filed: Mar. 24, 2022
(86) PCT No.: PCT/US2022/021777

§ 371 Date: Sep. 23, 2024

(51) Int. Cl. E06B 7/10; E06B 3/46; E06B 7/22

(52) U.S. Cl. CPC E06B 7/10; E06B 3/46; E06B 7/22

(57) ABSTRACT

A fenestration unit including a fenestration frame having a fenestration frame ventilation cavity, a sliding panel having a sliding panel ventilation cavity defined within the sliding panel frame and an air vent operable to provide fluid communication between the exterior side of the fenestration unit and the sliding panel ventilation cavity, a fixed panel including a fixed panel ventilation cavity defined within the fixed panel frame and an air vent operable to provide air flow between the exterior side of the fenestration unit and the fixed panel ventilation cavity, an interior seal positioned toward the interior side of the fenestration unit, the interior seal being substantially watertight and airtight when the fenestration unit is in a closed position; and an exterior seal positioned toward the exterior side of the fenestration unit, the exterior seal being substantially watertight when the fenestration unit is in the closed position.

### CROSS-REFERENCE TO RELATED APPLICATION

This application is a national phase application of PCT Application No. PCT/US22/21777, internationally filed on Mar. 24, 2022, which is incorporated herein by reference in its entirety for all purposes.

### BACKGROUND

Buildings and other structures are often constructed with fenestrations in which a fenestration unit (e.g., doors and windows) can be installed. Moisture ingress into fenestration units is one consideration in product design, construction, and installation. The fenestration unit may include a seal or a sealing system (e.g., gaskets, flanges, and the like) between the panels (e.g., sliding and/or fixed panels) of a fenestration unit and a frame of the fenestration unit to prevent moisture entry into the building. As might be expected, moisture intrusion is more problematic in high moisture situations with relatively increased exterior pressure (e.g., as is the case near oceans or during rainstorms). Pressure differentials between the exterior of the building and the interior of the building can have a negative effect on the effectiveness of the sealing system by pushing water through the seal. Some units address pressure differentials experienced by a sliding fenestration unit by utilizing a sill that includes a dam feature and drainage system to overcome the water column height of the water pressure.

### SUMMARY

A fenestration unit with an air and water management system that is capable of allowing pressure equalization with portions of the fenestration system to limit pressure pushing moisture through seals of the fenestration unit.

According to one example (“Example 1”), a fenestration unit is provided having an exterior side and an interior side, the fenestration unit comprising a fenestration frame configured to be positioned within a fenestration of a structure, the fenestration frame including a first jamb, a second jamb, a header, and a sill; a sliding panel operable to be slidably positioned with the fenestration frame, the sliding panel including a first stile, a second stile, an upper rail, and a lower rail defining a sliding panel frame, the sliding panel including a sliding panel ventilation cavity defined within the sliding panel frame and at least one air vent operable to provide fluid communication between the exterior side of the fenestration unit and the sliding panel ventilation cavity of the sliding panel frame; a fixed panel operable to be fixedly positioned with the fenestration frame, the fixed panel including a first stile, a second stile, an upper rail, and a lower rail defining a fixed panel frame, the fixed panel including a fixed panel ventilation cavity defined within the fixed panel frame and at least one air vent operable to provide air flow between the exterior side of the fenestration unit and the fixed panel ventilation cavity of the fixed panel frame; an interior seal positioned toward the interior side of the fenestration unit, the interior seal being substantially watertight and airtight when the fenestration unit is in a closed position; and an exterior seal positioned toward the exterior side of the fenestration unit, the exterior seal being substantially watertight when the fenestration unit is in the closed position, wherein the fenestration frame includes a fenestration frame ventilation cavity operable to receive air flow from the exterior side of the fenestration unit, the fenestration frame ventilation cavity defined at least partially between portions of the fenestration frame, the sliding panel and the fixed panel respectively, the interior seal, and the exterior seal.

According to another example (“Example 2”), further to Example 1, the sliding panel includes a plurality of corner lock members operable to couple the upper rail and the lower rail to each of the first and second stiles, wherein the corner locks define passages through which air can flow between the first stile, the second stile, the upper rail, and the lower rail within the sliding panel ventilation cavity.

According to another example (“Example”), further to Example 1, the sliding panel includes a first stile sealing member coupled to the first stile, the first stile sealing member including a first seal positioned on the exterior side of the fenestration unit and is substantially watertight when the sliding panel is in a closed position and a second seal positioned on an interior side of the fenestration unit and is substantially watertight and airtight when the sliding panel is in the closed position.

According to another example (“Example 4”), further to Example 1, the first stile sealing member includes a body operable to support the first seal and the second seal, the first stile sealing member spanning the first stile between the interior side of the fenestration unit and the exterior side of the fenestration unit, the body being at least partially spaced from the first stile such that a gap is formed between the body and the first stile, the gap being in fluid communication with the sliding member ventilation cavity.

According to another example (“Example 5”), further to Example 1, the sliding panel includes a second stile sealing member coupled to the second stile, the second stile sealing member including a first seal positioned between the first sliding panel and the fixed panel, the second stile sealing member being substantially watertight and airtight when the sliding panel is in a closed position.

According to another example (“Example 6”), further to Example 1, the lower rail of the sliding panel includes at least one ventilation aperture allowing fluid communication between the sliding panel ventilation cavity and the fenestration frame ventilation cavity.

According to another example (“Example 7”), further to Example 1, the fixed panel includes a plurality of vents operable to provide fluid communication between the fixed panel ventilation cavity and the fenestration frame ventilation cavity.

According to another example (“Example 8”), further to Example 1, the fenestration frame ventilation cavity is operable to receive air from the exterior side of the fenestration unit through the exterior seal.

According to another example (“Example 9”), further to Example 1, the fenestration frame ventilation cavity is in fluid communication with the sliding panel ventilation cavity and the fixed panel ventilation cavity.

According to another example (“Example 10”), further to Example 1, the at least one vent is positioned to allow air flow between the fixed panel ventilation cavity and the fenestration frame ventilation cavity at a space between the fixed panel and the second jamb of the fenestration frame.

According to another example (“Example 11”), further to Example 1, the at least one vent is positioned to allow air flow between the fixed panel ventilation cavity and the fenestration frame ventilation cavity at a space between the fixed panel and the header of the fenestration frame.

According to another example (“Example 12”), further to Example 1, the at least one vent is positioned to allow air flow between the fixed panel ventilation cavity and the fenestration frame ventilation cavity at a space between the fixed panel and the sill of the fenestration frame.

According to another example (“Example 13”), further to Example 1, the fenestration unit further includes a fixed cover operable to be coupled to the fenestration frame on the interior side of the fenestration unit, the fixed cover forming a portion of the interior seal and providing a substantially airtight and watertight seal with the fixed panel and the fenestration frame.

According to another example (“Example 14”), further to Example 1, the at least one vent is positioned to allow air flow between the exterior side of the fenestration unit and a space between the fixed cover and the sill of the fenestration frame.

According to another example (“Example 15”), further to Example 1, the at least one vent includes a downward slope from the interior side of the fenestration unit toward the exterior side of the fenestration unit.

According to another example (“Example 16”), further to Example 1, the sliding panel and the fixed panel each include a respective glazing cavity, and wherein at least one of the fixed panel and the sliding panel includes at least one air vent providing fluid communication between the sliding panel ventilation cavity or the fixed panel ventilation cavity and the respective glazing cavity.

According to another example (“Example 17”), further to Example 1, the at least one vent is positioned proximate three corners of the fixed panel and the fenestration frame ventilation cavity.

According to one example (“Example 18”), a fenestration unit for reducing moisture entry due to pressure differentials is provided, the fenestration unit having an interior side and an exterior side, the fenestration unit including a sliding panel including a glazing unit and a sliding panel frame, the sliding panel frame including first stile, a second stile, an upper rail, and a lower rail, the sliding panel frame defining a glazing cavity within which the glazing unit supported by the sliding panel frame, the sliding panel frame including a sliding panel ventilation cavity defined within the sliding panel frame, the sliding panel frame including at least one air vent operable to provide fluid communication between the sliding panel ventilation cavity and the glazing cavity; and a fixed panel including a glazing unit and a fixed panel frame, the fixed panel frame including first stile, a second stile, an upper rail, and a lower rail, the fixed panel frame defining a glazing cavity within which the glazing unit supported by the fixed panel frame, the fixed panel frame including a fixed panel ventilation cavity defined within the fixed panel frame, the fixed panel frame including at least one air vent operable to provide fluid communication between the fixed panel ventilation cavity and the glazing cavity.

According to one example (“Example 19”), a panel for a fenestration unit for reducing moisture entry due to pressure differentials is provided, the panel having an interior side and an exterior side, the panel including a panel frame including a first stile, a second stile, an upper rail, a lower rail, and a plurality of corner lock members operable to couple the upper rail and the lower rail to each of the first and second stiles, the panel frame defining a ventilation cavity, wherein the corner locks define passages through which air can flow between the first stile, the second stile, the upper rail, and the lower rail within the ventilation cavity, the panel frame defining a glazing cavity; a glazing unit supported by the sliding panel frame within the glazing cavity; an interior seal operable to define a pressure differential; and an exterior seal operable to shed water.

According to another example (“Example 20”), further to Example 19, the panel frame includes at least one vent defined within at least one of the first stile, the second stile, the upper rail, and the lower rail, the at least one vent operable to allow fluid communication between the a glazing cavity and the ventilation cavity.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a front view of an exterior side of a fenestration unit with a fixed and sliding panel in accordance with some embodiments;

FIG. 2 is a front view of an interior side of a fenestration unit with a fixed and sliding panel in accordance with some embodiments;

FIG. 3 is an isometric view of the exterior side of the fenestration unit with schematic airflow arrows indicated in accordance with some embodiments;

FIG. 4 is a front view of the exterior side of a sliding panel in in

accordance with an embodiment;

FIG. 5 is a front cut-out view of an intersection of a first stile and an upper rail of the exterior side of a sliding panel of FIG. 4 in accordance with some embodiments;

FIG. 6A is a front view of a corner lock member with schematic airflow arrows indicated in accordance with some embodiments;

FIG. 6B is an isometric view of the corner lock member of FIG. 6A; in accordance with some embodiments;

FIG. 6C is side isometric view of the corner lock member of FIG. 6A in accordance with some embodiments;

FIG. 7 is a side isometric view of a first stile of an exterior side of a sliding panel in accordance with some embodiments;

FIG. 8 is an isometric view of a plurality of vents proximate the first stile of FIG. 7, in accordance with some embodiments;

FIG. 9 is a top-down isometric view of a first stile of a sliding panel in accordance with some embodiments;

FIG. 10 is an isometric view of the first stile of FIG. 9, in accordance with some embodiments;

FIG. 11A is an isometric view of an intersection of an upper rail and a first stile of a sliding panel in accordance with some embodiments;

FIG. 11B is an isometric view of FIG. 11A with a sealing member removed;

FIG. 12A is an isometric top-view of the upper rail of the exterior side of the sliding panel in FIGS. 11A-11B;

FIG. 12B is an isometric view of the upper rail of FIG. 11B with the sealing member removed;

FIG. 12C is a cut-away top-view of FIG. 11A and 11B with an upper rail removed;

FIG. 13 is a front view of an intersection of an upper rail and second stile of the exterior side of the sliding panel of FIG. 4;

FIG. 14A is an isometric top-view of the exterior side of a sliding panel in accordance with an embodiment;

FIG. 14B is an isometric view of an intersection of the upper rail and the second stile of FIG. 14A;

FIG. 15 is an isometric view of an intersection of the lower rail and the second stile of FIG. 4;

FIG. 16 is a cut-away front view of a lower rail of the exterior side of the sliding panel of FIG. 4;

FIG. 17 is an isometric view bottom-view of an intersection of a lower rail and a first stile of the exterior side of a sliding panel in accordance with an embodiment;

FIG. 18 is a section view of a sliding panel ventilation cavity of a lower rail of a sliding panel in accordance with an embodiment;

FIG. 19 is a perspective section view of the sliding panel ventilation cavity of a sliding panel in accordance with an embodiment;

FIG. 20 is a front view of the exterior side of a fixed panel with schematic airflow arrows indicated in accordance with some embodiments;

FIG. 21 is a cut-away front view of an intersection of a first stile and a lower rail of the exterior side of the fixed panel of FIG. 20;

FIG. 22 is a perspective view of a stile of a fixed panel in accordance with some embodiments;

FIG. 23 is an isometric view of an intersection of the upper rail and a stile of a fixed panel in accordance with some embodiments;

FIG. 24 is an isometric view of the exterior of the fenestration unit in with schematic airflow arrows indicated in accordance with some embodiments;

FIG. 25 is an isometric view of a plurality of vents allowing an air flow within the sliding panel of the fenestration unit of FIG. 24 with schematic airflow arrows indicated;

FIG. 26 is an isometric view of a plurality of vents allowing an air flow within a sill of a fenestration frame of the fenestration unit in FIG. 24 with schematic airflow arrows indicated;

FIG. 27 is a front view of one of the plurality of vents of FIG. 26 with schematic airflow arrows indicated;

FIG. 28 is an isometric view of a plurality of vents on an interior of a fenestration unit in accordance with some embodiments;

FIG. 29 is an isometric cut-out view of one of the plurality of vents into a space formed within an interior cover of FIG. 28 with a schematic airflow arrow indicated;

FIG. 30 is an isometric view of FIG. 29 showing the interior cover;

FIG. 31 is a section view of a sliding panel and fixed panel with an interlocker in accordance with some embodiments;

FIG. 32 is a section view of a fixed panel and a fenestration frame with a spacer in accordance with an embodiment;

FIG. 33 is an illustration of the spacer of FIG. 32;

FIG. 34 is an illustration of a fenestration unit ventilation cavity between a fixed panel and a header in accordance with an embodiment;

FIG. 35 is an illustration of a fenestration unit ventilation cavity between a fixed panel and a sill in accordance with an embodiment;

FIG. 36 is an illustration of a fenestration unit ventilation cavity between a sliding panel and a sill in accordance with an embodiment;

FIG. 37 is an illustration of a fenestration unit ventilation cavity between a sliding panel and a header in accordance with an embodiment; and

FIG. 38 is an illustration of a fenestration unit ventilation cavity between a sliding panel and a jamb in accordance with an embodiment.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

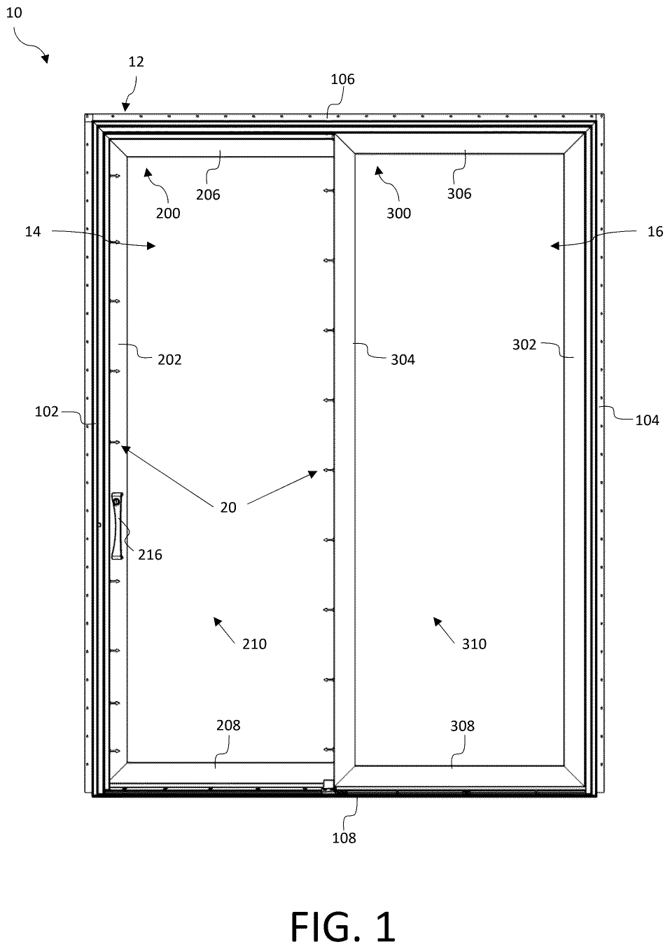

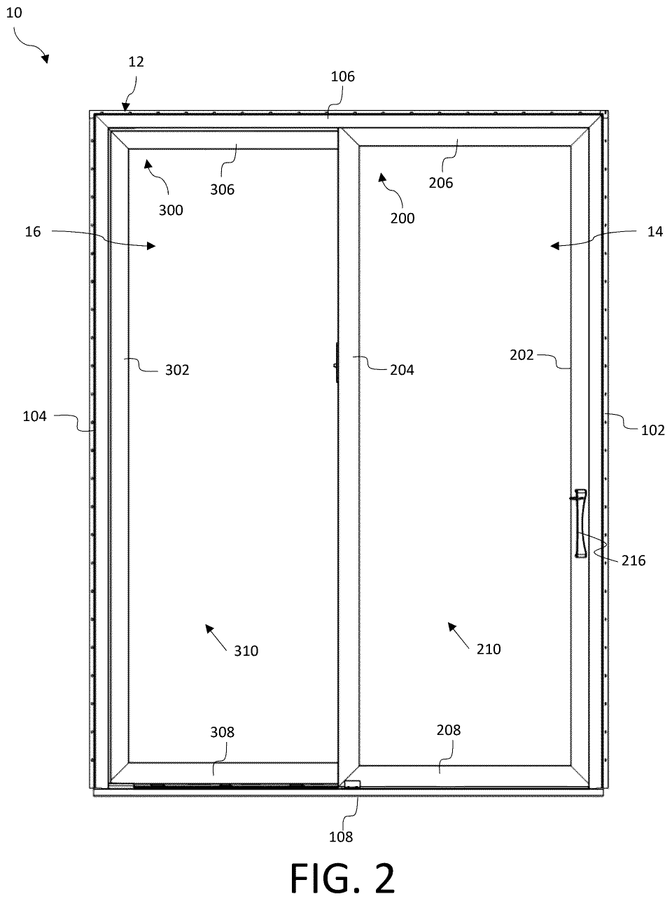

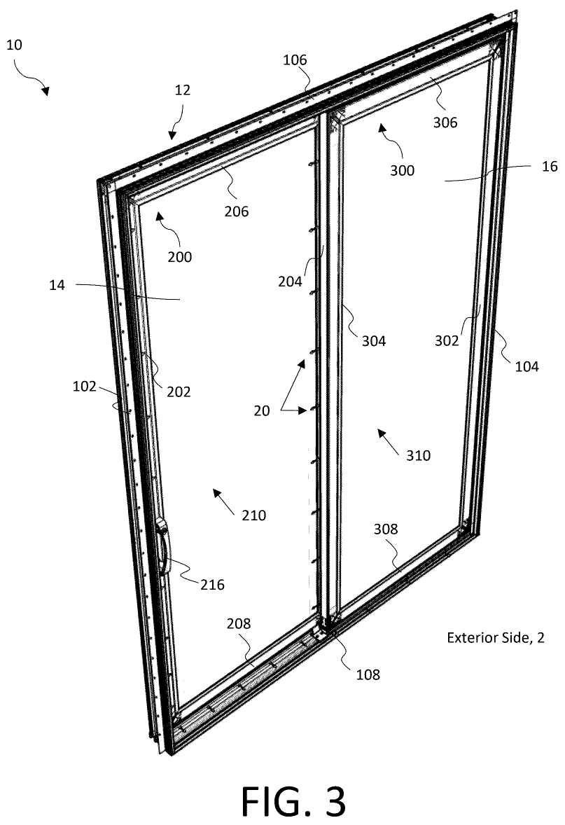

FIG. 1 depicts a fenestration unit 10 for installation in a building structure (not shown). The fenestration unit 10 includes a water management system to reduce or prevent water penetration into an interior of a structure through the fenestration unit 10. FIG. 1 depicts an exterior side 2 of the fenestration unit 10 as the fenestration unit 10 would be viewed from an exterior of a building structure (not shown) in which it is installed. FIG. 2 depicts the fenestration unit 10 from an interior side 4 (e.g., corresponding to how the fenestration unit 10 would be viewed from an interior of the building structure), and FIG. 3 is an isometric view of the fenestration unit 10 from the exterior side 2. The water management system of the fenestration unit 10 is operable to limit water from entering into the fenestration unit under positive pressure due to high exterior pressures caused by high barometric pressure, wind, and the like. By providing a fenestration unit 10 with a water management system that allows ventilation of air through spaces within the components of the fenestration unit 10, the high exterior pressures are able to be equalized behind one or more water seals to help avoid moisture from being introduced against and through an interior seal of the fenestration unit 10.

Referring further to FIG. 1, the fenestration unit 10 is shown from an exterior side 2 as the fenestration unit 10 would be viewed from an exterior of a building structure (not shown) in which it is installed. As shown, the fenestration unit 10 includes a frame 12, a sliding panel 14, and a fixed panel 16. The frame 12 is operable to be positioned in an opening of a structure and supports the sliding and fixed panels 14, 16. For example, the fenestration unit 10 being depicted is a sliding door unit, but it is understood that the fenestration unit 10 described herein may also be implemented with respect to sliding windows. Schematic arrows 20 are depicted in FIG. 1 and throughout the drawings, and those arrows 20 indicate airflow as it relates to the various components of the fenestration unit 10. For example, the schematic arrows 20 in FIG. 1 depict airflow from an exterior side 2 of the fenestration unit 10 into interior spaces of the fenestration unit 10 (e.g., between the frame 12 and the sliding panel 14). The schematic arrows 20 are depicted throughout the figures and are discussed in more detail with respect to the specific figures for description of airflow in the fenestration unit 10.

As shown, the frame 12 of the fenestration unit 10 includes a first jamb 102, a second jamb 104, a header 106, and a sill 108. The frame 12 and its components are installed in the opening of a structure and support the sliding panel 14 and the fixed panel 16. Various ventilation cavities and vents are provided throughout the fenestration unit 10 to facilitate pressure equalization/neutralization throughout the fenestration unit 10. By facilitating pressure equalization, the fenestration unit 10 is able to facilitate a lower profile sill height while maintaining water performance (e.g., prevents or limits water intrusion through the fenestration unit). In some embodiments, the fenestration unit 10 may include a sill height that is less than the water column height when implementing the ventilation cavities and/or vents described herein. It is further understood that the features described herein also facilitate water performance without requiring robust or uninterrupted seals around the entire fenestration unit and its component parts to maintain the level of water performance.

Although described hereafter in more detail, some of the ventilation cavities described herein include a fenestration frame ventilation cavity 50 which is defined between the fenestration frame 12 and each of the sliding panel 14 (e.g., in the closed position) and the fixed panel 16, a sliding panel ventilation cavity 212 defined within a sliding panel frame 200 and a fixed panel ventilation cavity 312 defined with a fixed panel frame 300. The fenestration frame ventilation cavity 50, the sliding panel ventilation cavity 212, and the fixed panel ventilation cavity 312 are each in fluid communication (e.g., air communication) and are in air communication with air exterior to the fenestration unit 10, either individually, collectively, or both.

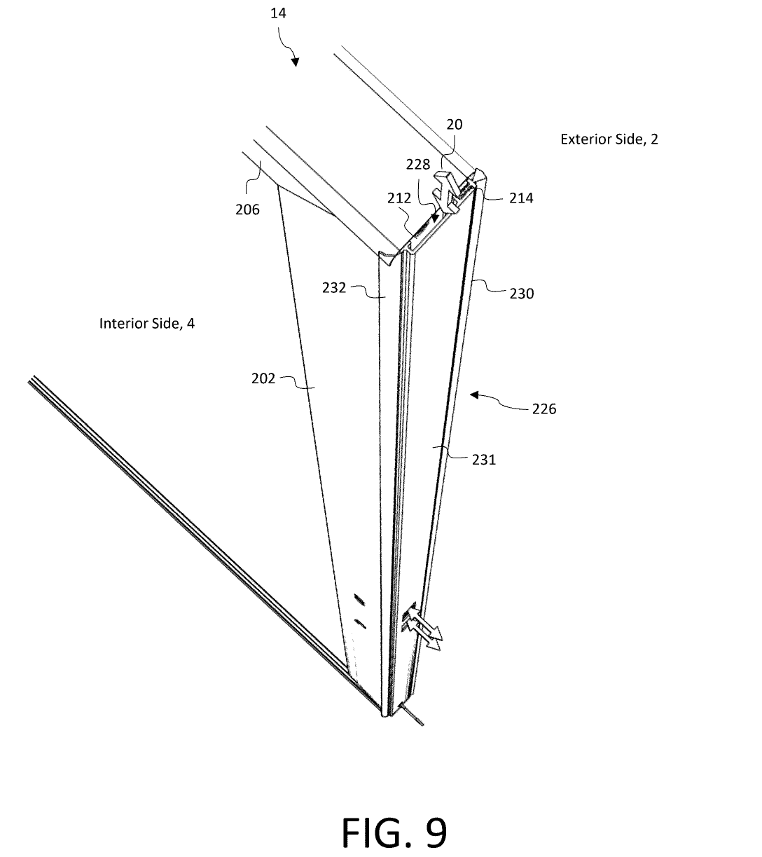

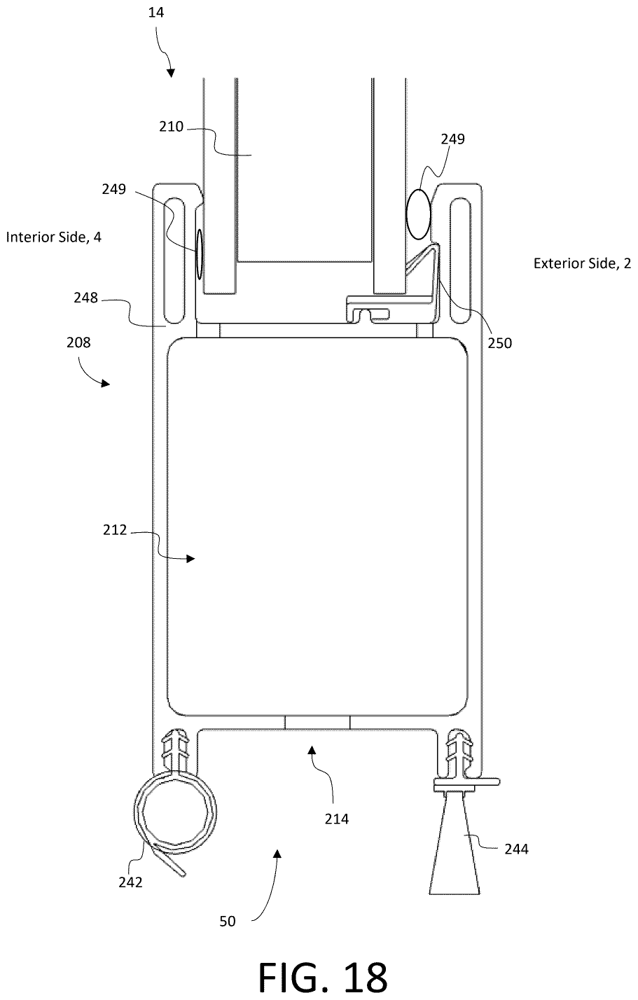

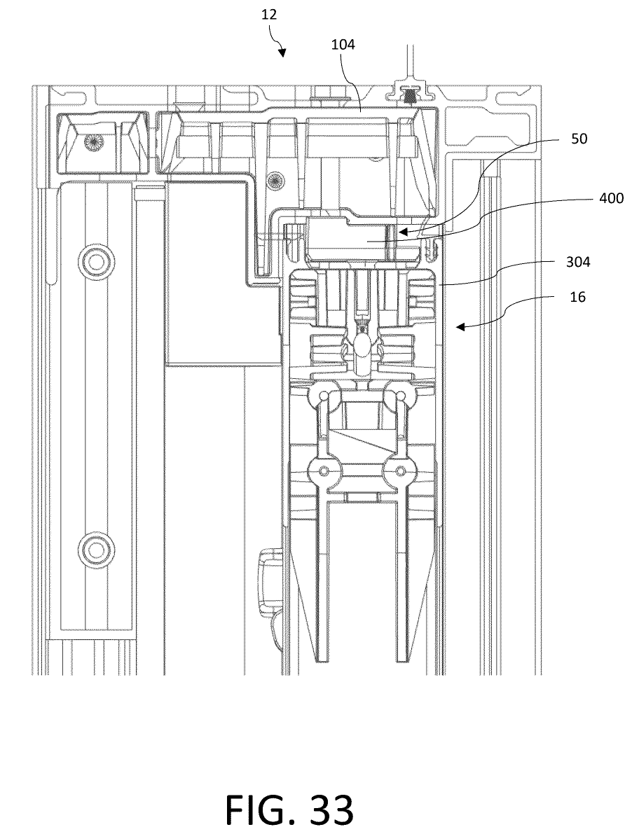

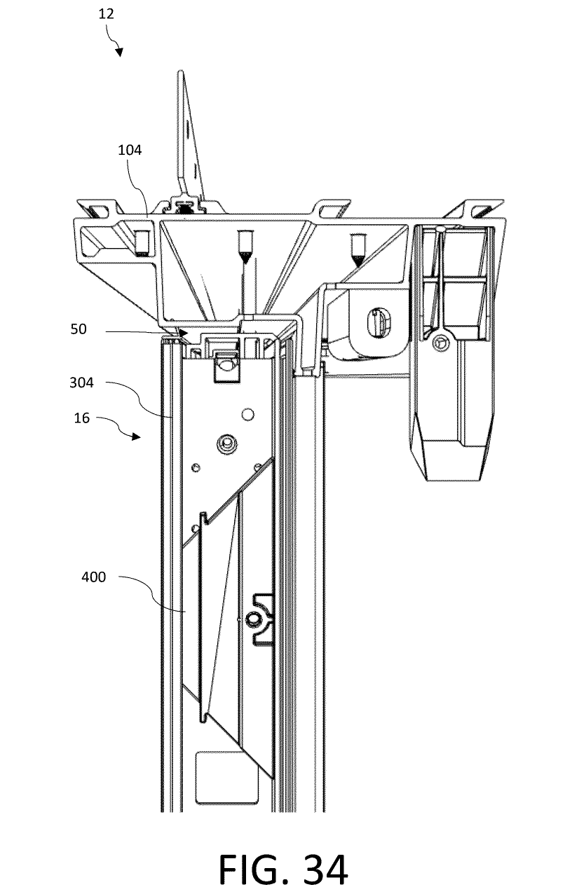

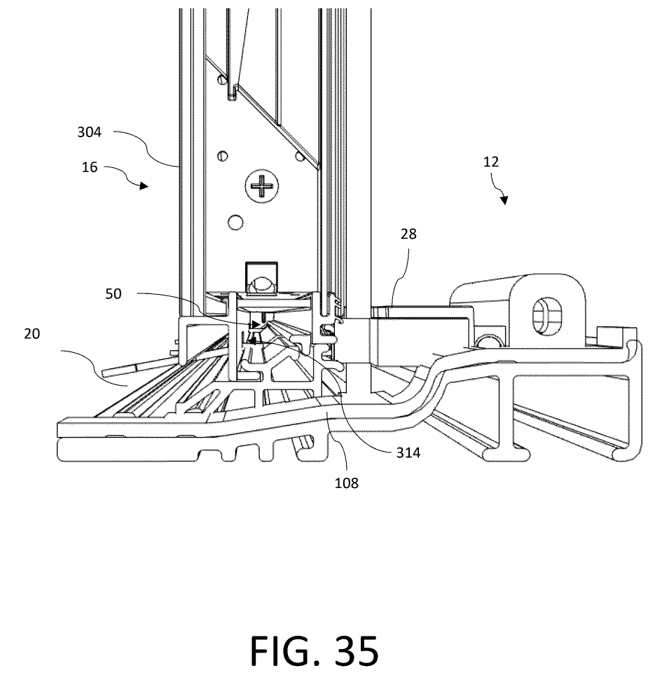

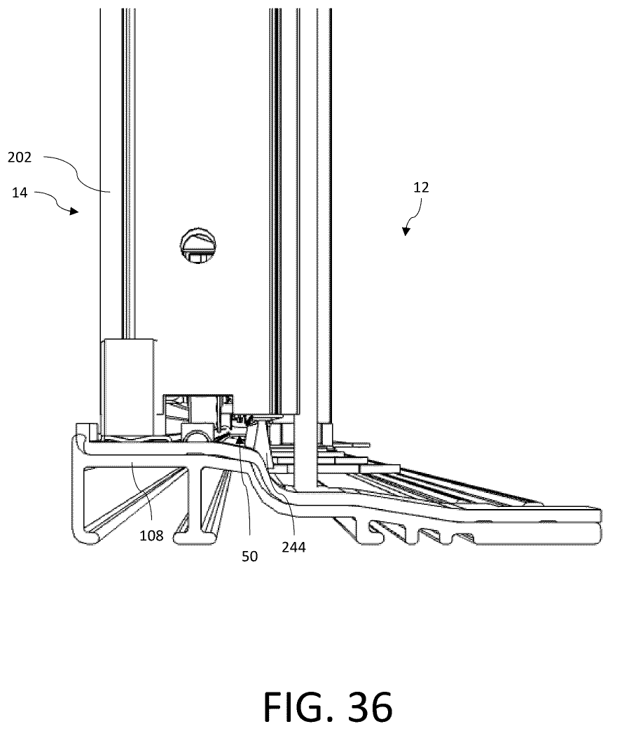

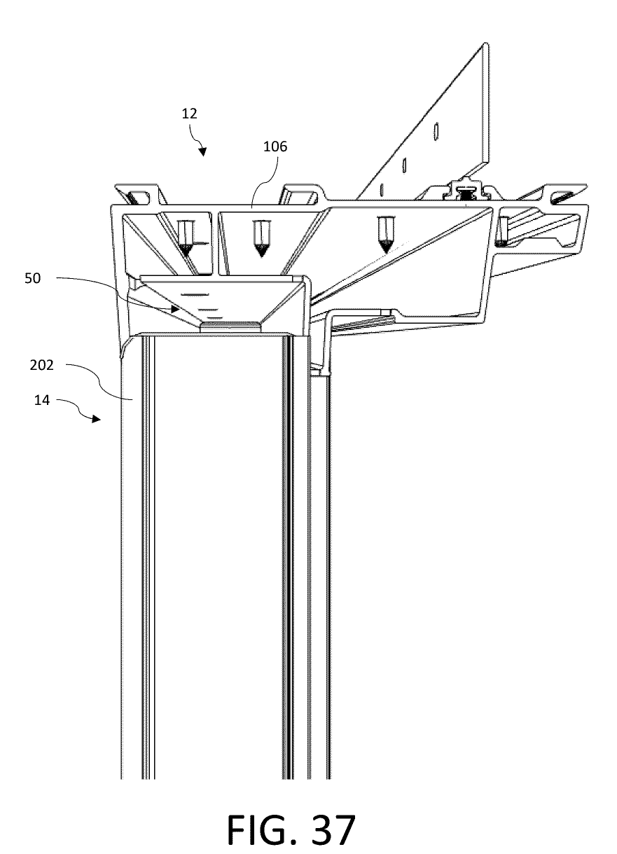

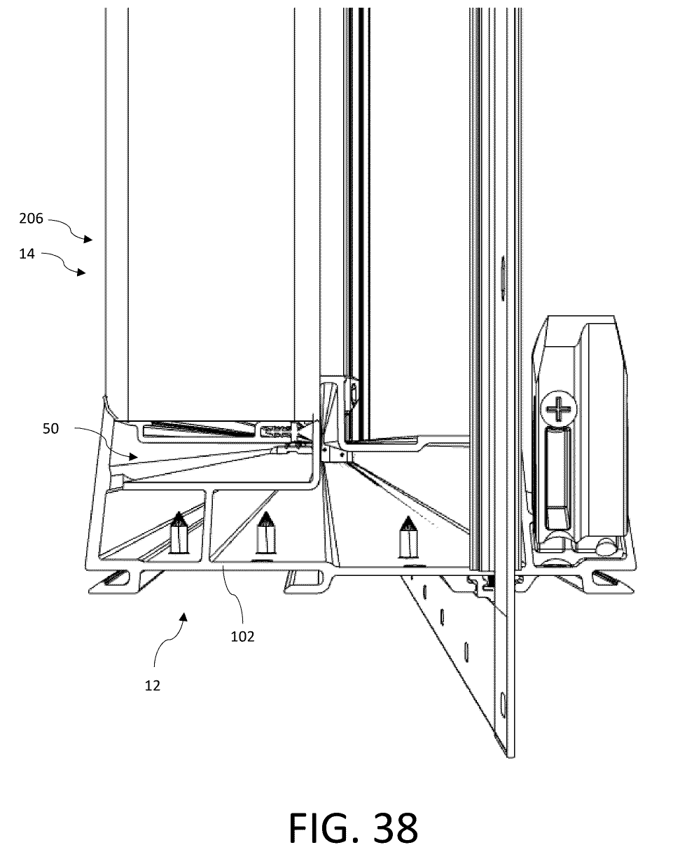

With reference to FIGS. 33-38, the fenestration frame ventilation cavity 50 is generally illustrated at various positions about the fenestration unit 10. Generally, the fenestration frame ventilation cavity 50 is defined between the panels (e.g., the sliding panel 14 and the fixed panel 16) and the fenestration frame 12 and interior seals (e.g., second seal 232, FIG. 9; interior seal 242, FIG. 18; and so forth) and exterior seals (e.g., first seal 230, FIG. 9; exterior seal 244, FIG. 18). Referring to FIG. 33, the fenestration frame ventilation cavity 50 is defined between the second jamb 104 of the fenestration frame 12 and the first stile 302 of the fixed panel 16. FIG. 34 depicts the fenestration frame ventilation cavity 50 defined between the upper rail 306 of the fixed panel 16 and the header 106 of the fenestration frame 12. FIG. 35 illustrates the fenestration frame ventilation cavity 50 defined between the lower rail 308 of the fixed panel 16 and the sill 108 of the fenestration frame 12. FIG. 36 illustrates the fenestration frame ventilation cavity 50 defined between the lower rail 208 of the sliding panel 14 and the sill 108 of the fenestration frame 12. FIG. 37 depicts the fenestration frame ventilation cavity 50 defined between the upper rail 206 of the sliding panel 14 and the header 106 of the fenestration frame 12. FIG. 38 depicts the fenestration frame ventilation cavity 50 defined between the first jamb 102 of the fenestration frame 12 and the first stile 202 of the sliding panel 14. The fenestration frame ventilation cavity 50 is generally defined in the spaces described and the exterior side 2 and the interior side 4 of the fenestration unit 10. For example, the fenestration unit 10 generally includes exterior seals that limit water penetration while allowing air flow therethrough and interior seals that limit both air and water flow therethrough (the interior and exterior seals are discussed in more detail throughout and include, but are not limited to first seal 230, second seal 232, first sealing member 236, first and second transition sealing members 237, 238, interior seal 242, exterior seal 244, and so forth). The seals may be positioned about a periphery of the fenestration frame 12, the sliding panel 14, the fixed panel 16, and combinations thereof. As is discussed throughout, the fenestration frame ventilation cavity 50 as well as other ventilation cavities are discussed to facilitate pressure equalization which limits water intrusion through the fenestration unit 10. Air is operable to flow into the fenestration frame ventilation cavity 50 as is discussed herein in more detail.

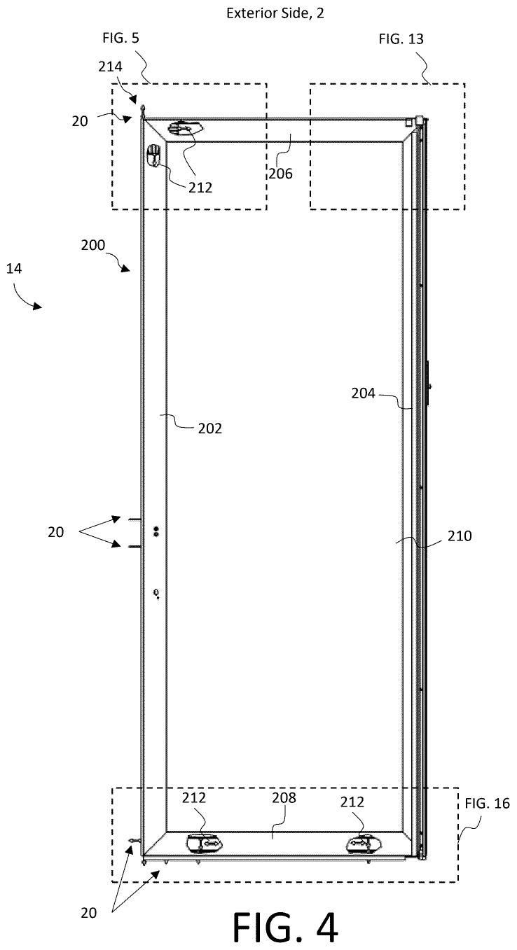

Referring again to FIG. 1, the sliding panel 14 is slidably positioned with the fenestration frame 12. The sliding panel including a first stile 202, a second stile 204, an upper rail 206, and a lower rail 208 defining a sliding panel frame 200. The sliding panel 14 may include a glazing unit 210 supported by the sliding panel frame 200. The sliding panel 14 includes a sliding panel ventilation cavity 212 (FIGS. 4, 5, 8, 9, 16, 18, and so forth) defined within the sliding panel frame 200 and a plurality of air vents 214 (FIGS. 4, 5, 7-12, 16-19, and so forth) operable to provide fluid communication between the exterior side 2 of the fenestration unit 10 and the sliding panel ventilation cavity 212 of the sliding panel frame 200 (FIG. 1). The first stile 202 of the sliding panel 14 is positioned with a handle 216 (see FIGS. 1-3) which can be actuated to slide the sliding panel 14 between open and closed positions.

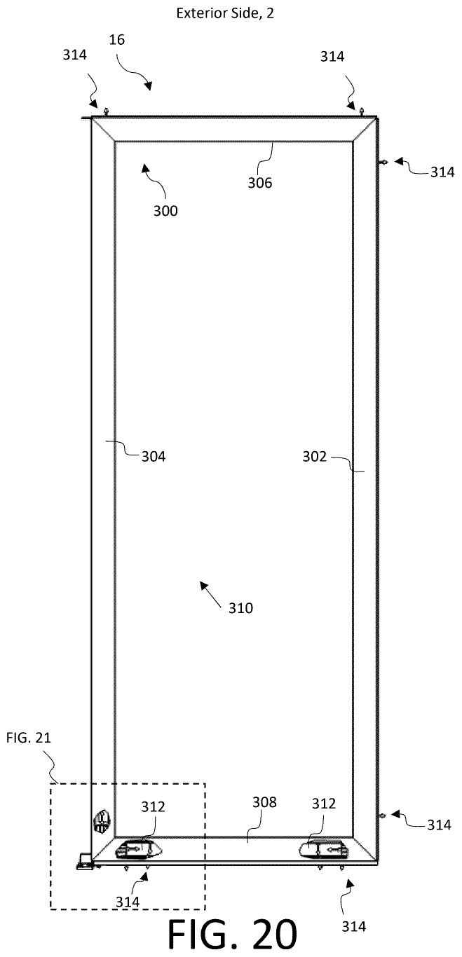

The handle 216 can include locking components 218 for engaging and/or locking the sliding panel 14 in the closed position. For example, the sliding panel 14 may be engaged with the fenestration frame 12 in the closed position when the locking components 218 engage corresponding structure on the fenestration frame 12 limiting the movement of the sliding panel 14. As will be further referenced below, FIGS. 4-19 depict the sliding panel 14 in more detail. The fixed panel 16 is fixedly positioned with the fenestration frame 12. The fixed panel 16 includes a first stile 302, a second stile 304, an upper rail 306, and a lower rail 308 defining a fixed panel frame 300. The fixed panel 16 may include a glazing unit 310 supported by the fixed panel frame 300. The fixed panel 16 also optionally includes a fixed panel ventilation cavity 312 defined within the fixed panel frame 300 and a plurality of air vents 314 (see FIGS. 20-23) operable to provide fluid communication between the exterior side 2 of the fenestration unit 10 and the fixed panel ventilation cavity 312 of the fixed panel frame 300. The first stile 302 of the fixed panel 16 is positioned against the second jamb 104 of the fenestration frame 12. As will be further referenced below, FIGS. 20-23 depict the fixed panel 16 in more detail. Although the sliding and fixed panels 14, 16, respectively, may include glazing as described, in various embodiments the sliding panel 14 and/or fixed panel 16 optionally includes opaque, solid or filled panel designs that are not otherwise transparent (e.g., wood, tile, fiberglass, vinyl, or other central paneling).

FIG. 4 is a front view of the exterior side 2 of the sliding panel 14 with cutaway portions for showing interior features of the sliding panel 14. The interior features include the sliding panel ventilation cavity 212 and other features for facilitating air flow and pressure equalization. As shown in FIG. 4, the sliding panel ventilation cavity 212 is defined within the sliding panel frame 200 such that the various components of the frame 200 are in fluid communication with each other. The air vents 214 are positioned about the periphery of the sliding panel frame 200 such that air may enter and exit the sliding panel ventilation cavity 212 from a plurality of positions, thus facilitating responsive air pressure equalization. For example, air vents 214 are positioned about the periphery of the first stile 202, the upper rail 206, and the lower rail 208. Air vents 214 of FIG. 4 are generally positioned at least where the schematic arrows 20 are seen in the drawing.

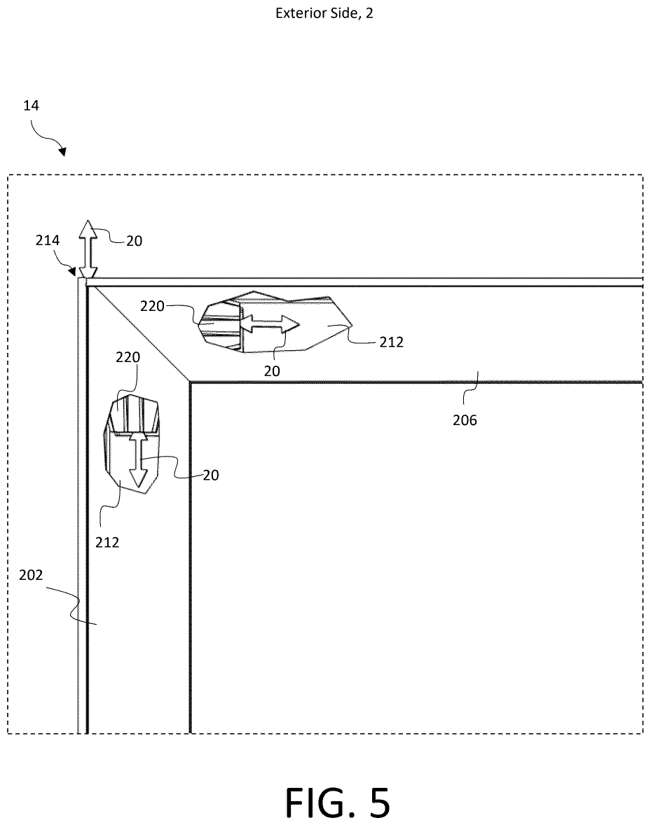

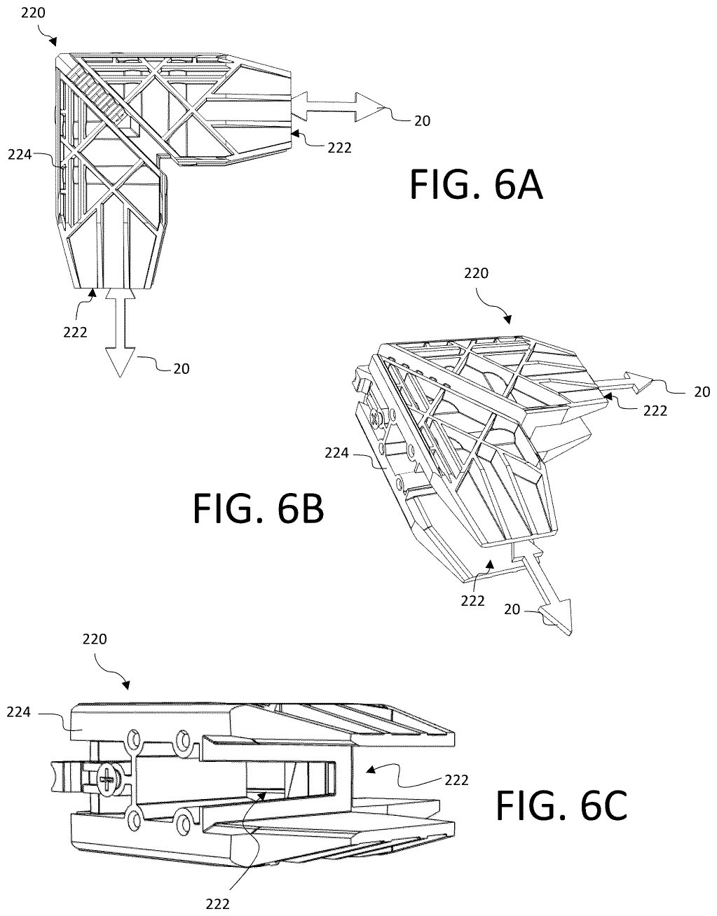

FIG. 5 illustrates an intersection of the first stile 202 and the upper rail 206 of the exterior side 2 of the sliding panel 14 as shown in FIG. 4. The first stile 202 and the upper rail 206 are shown with portions cutaway to illustrate the inner components of the sliding panel 14, including the sliding panel ventilation cavity 212 defined within the sliding panel frame 200. The sliding panel ventilation cavity 212 is in fluid communication (e.g., air flow) with the exterior side 2 of the sliding panel 14. The stiles 202, 204 and rails 206, 208 are coupled to each other by a corner lock member 220. When the corner lock member 220 is positioned to couple members of the sliding panel frame 200, for example, the first stile 202 and the upper rail 206, air flow between the sliding panel ventilation cavity 212 of the first stile 202 and the sliding panel ventilation cavity 212 of the upper rail 206 is maintained because air can flow past (e.g., through) the corner lock member 220. For example, FIGS. 6A-6C illustrate the corner lock member 220 with at least one channel or passage 222 defined through the body 224 of the corner lock member 220 through which air can flow.

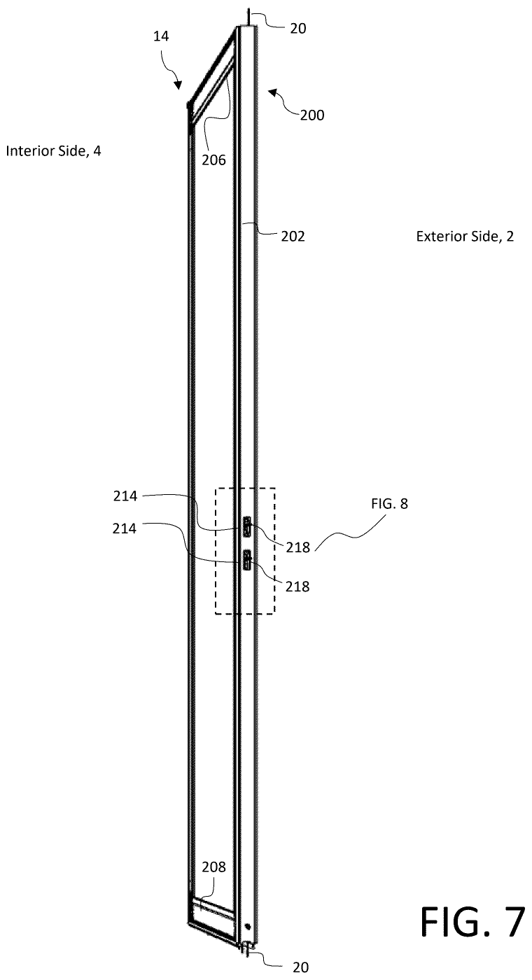

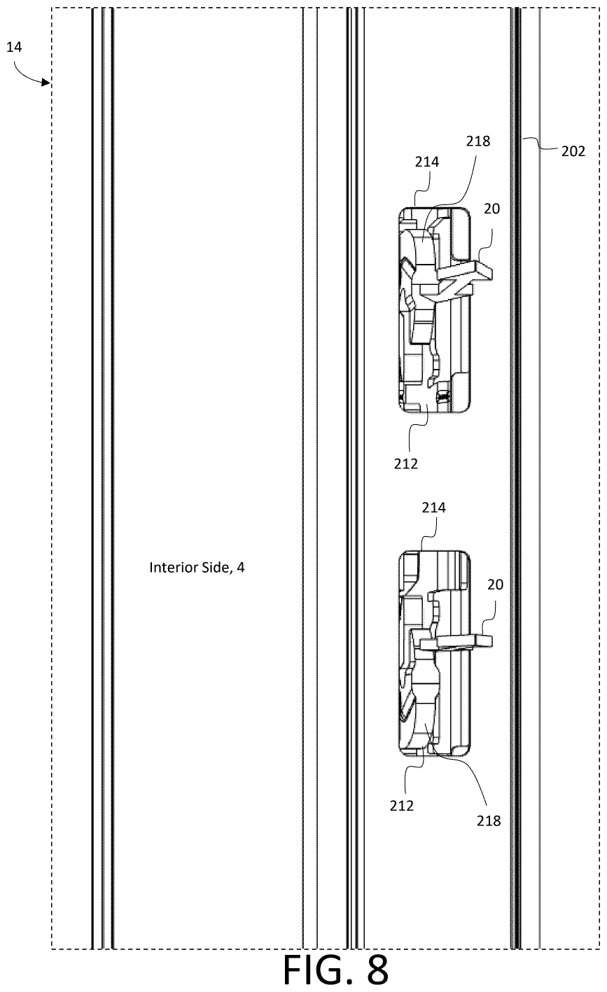

The air vents 214 are positioned at various positions about the sliding panel frame 200. For example, FIGS. 7 and 8 illustrate air vents 214 allowing fluid communication into the sliding panel ventilation cavity 212. The air vents 214 illustrated are positioned at the where the locking components 218 are housed within the sliding panel frame 200 shown in FIG. 4.

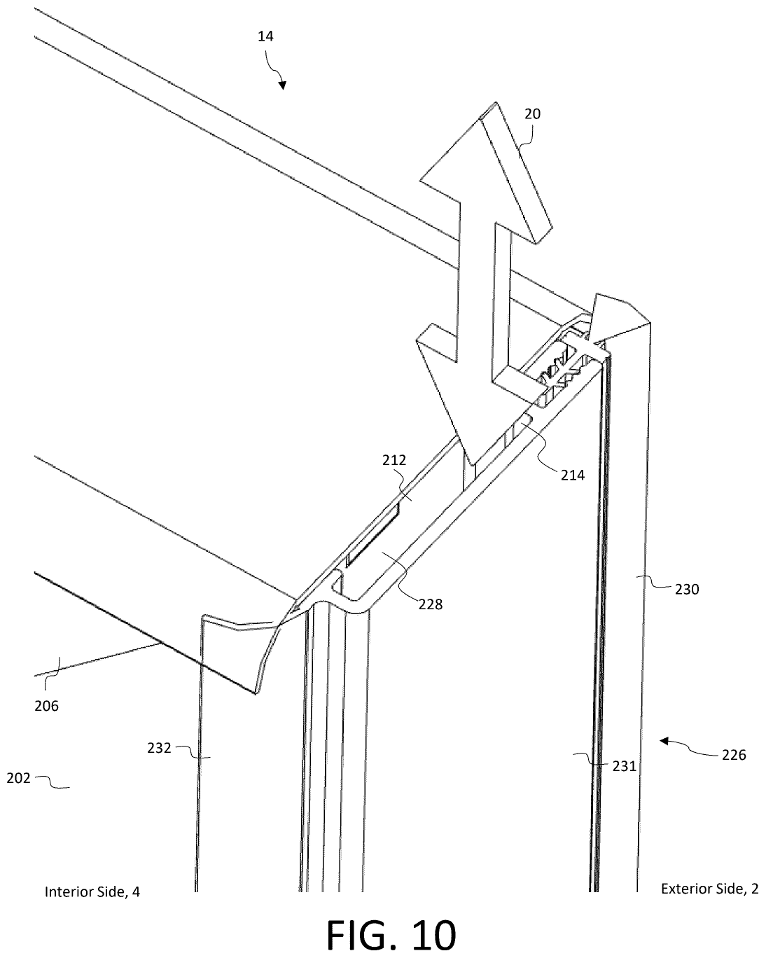

Referring to FIGS. 9 and 10, another air vent 214 is illustrated. For example, the sliding panel 14 may include a first stile sealing member 226 that is positioned adjacent the first stile 202. The first stile sealing member 226 is spaced from the first stile 202 to form a gap or cavity 228 into and out of which air may flow. The first stile sealing member 226 includes a body 231 operable to support a first seal 230 and a second seal 232, the first stile sealing member 226 spanning the first stile 202 between the interior side 4 of the fenestration unit 10 and the exterior side 2 of the fenestration unit 10, the body 231 being at least partially spaced from the first stile 202 such that the gap 228 is formed between the body 231 and the first stile 202, the gap 228 being in fluid communication with the sliding member ventilation cavity 212. The first stile sealing member 226 may include a first seal 230 and a second seal 232. The first seal 230 is positioned on the exterior side 2 of the sliding panel 14 and the second seal 232 is positioned on the interior side 4 of the sliding panel 14. The first seal 230 may include a brush seal which limits water, particulate matter, and insects from passing past the first seal 230 while still allowing air to flow through the first seal 230. The second seal 232 may include a waterproof and airproof seal that limits ingress of air and moisture beyond the second seal 232 when the sliding panel 14 is in the closed position (e.g., the first and second seals 230, 232 are positioned against the fenestration frame 12 when the sliding panel 14 is in the closed positioned). By having the first seal 230 allow air to flow through, the ventilation cavity 212 and the fenestration frame ventilation cavity 50 can receive air flow from the exterior side 2 of the fenestration unit 10 (either directly or indirectly) when the sliding panel 14 is in the closed position, and vice versa. Thus, the air pressure of the sliding member ventilation cavity 212 and the fenestration frame ventilation cavity 50 can equalize with the air on the exterior side 2 of the fenestration unit 10. When the air pressure is equalized, it is less likely that water will penetrate the fenestration unit 10 as the air pressure is equalized such that there is not a pressure gradient across the first seal 230 encouraging water entry into the space between the first seal 230 and the second seal 232.

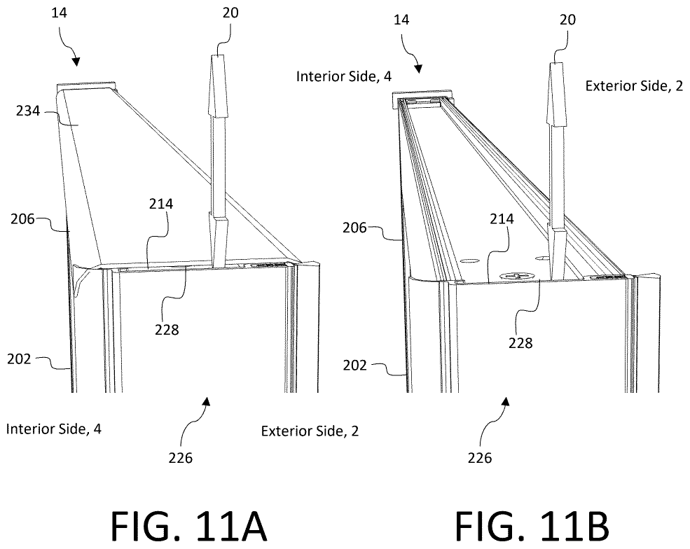

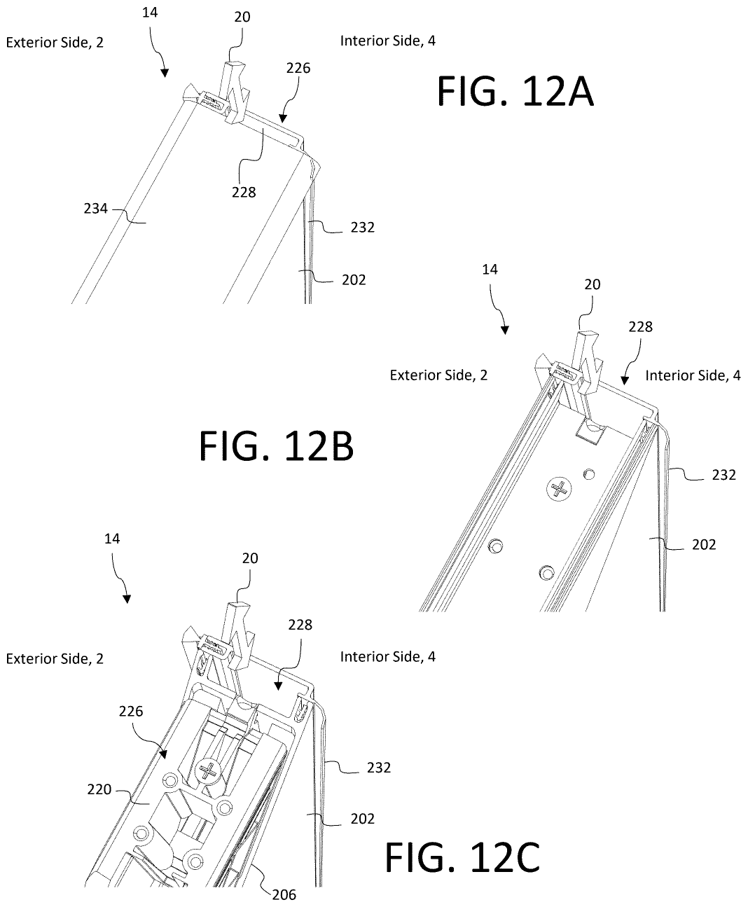

Referring to FIG. 11A and FIG. 12A, an upper rail cover 234 is shown which provides seals between the upper rail 206 and the fenestration frame 12 (shown in FIG. 1). The upper rail cover 234 does not extend all the way to the outer surface of the first stile sealing member 226 such that a gap 228 is formed, the gap 228 forming one of the air vents 214. FIGS. 11B and 12B illustrate the sliding panel 14 with the upper rail cover 234 removed which depicts the gap 228 between the first stile sealing member 226 and the first stile 202 in more detail. FIG. 12C illustrates the corner lock member 220 positioned in the first stile 202 with the first stile sealing member 226 spaced from the first stile 202.

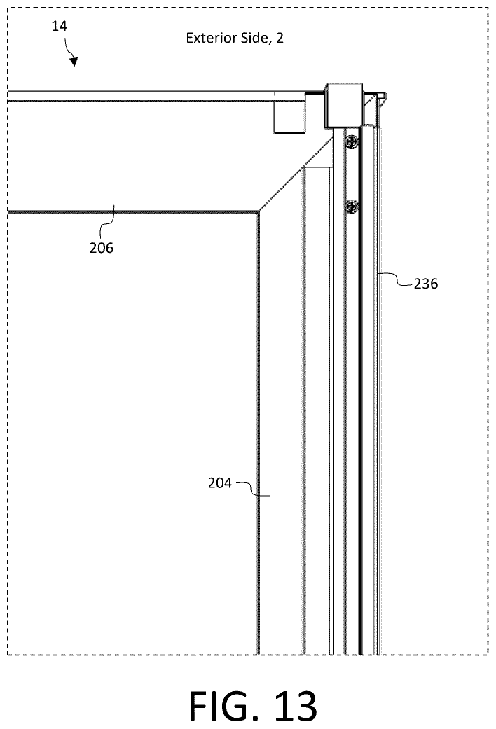

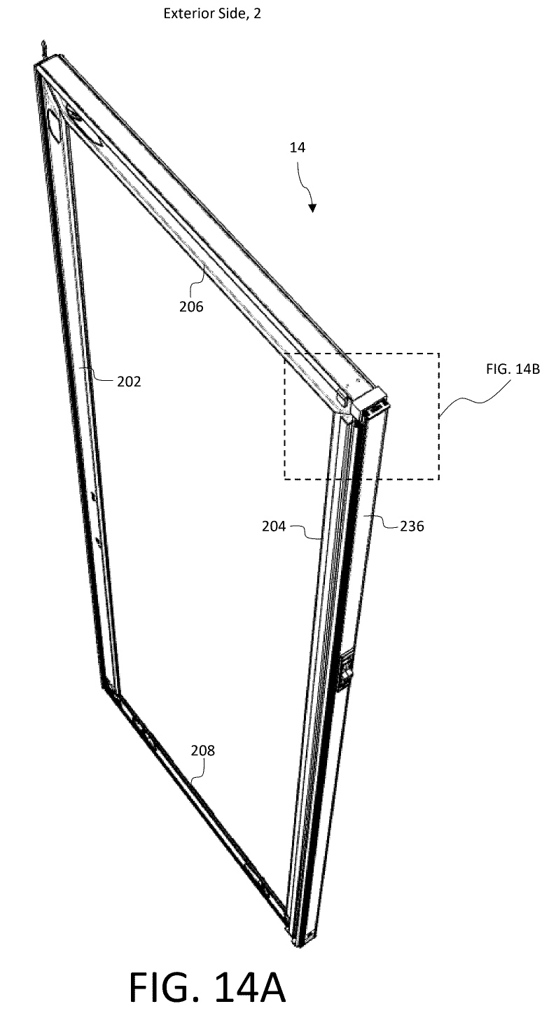

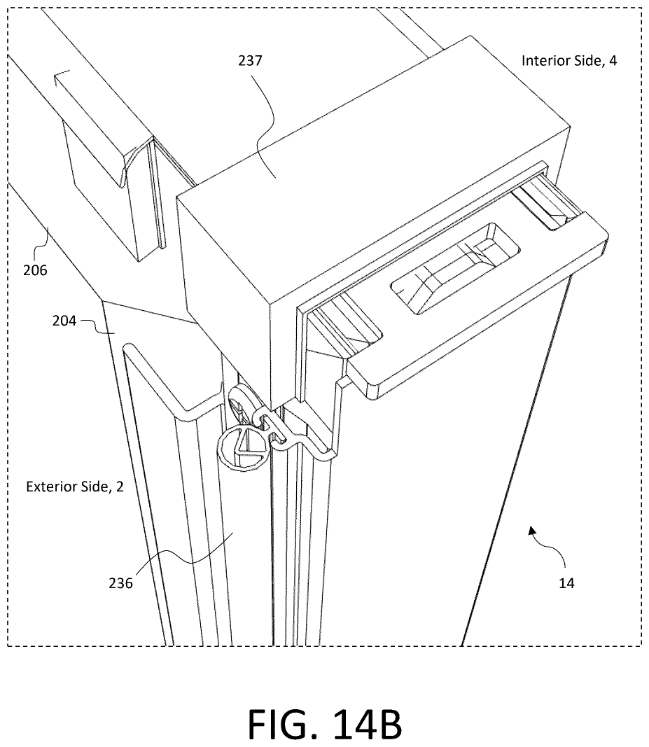

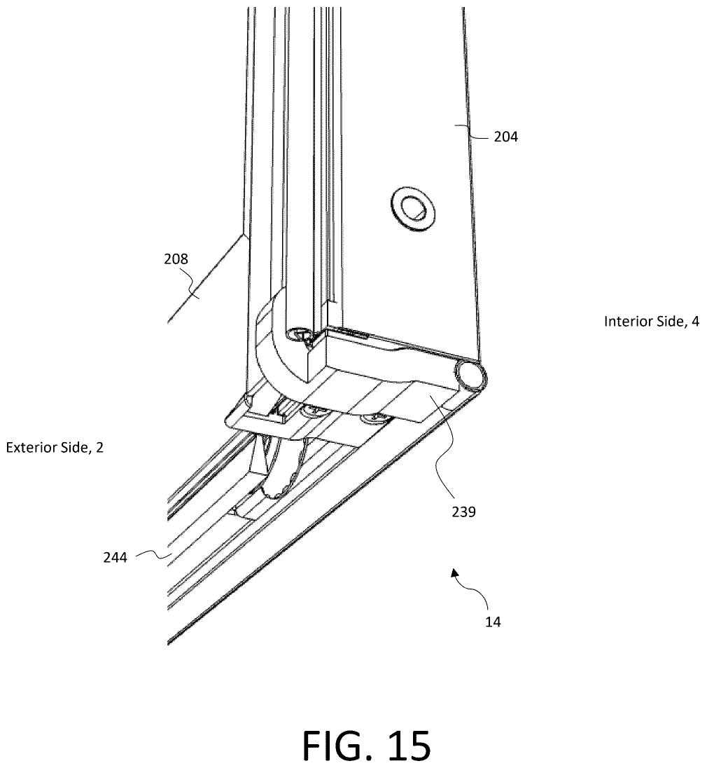

FIGS. 13-15 are views of an intersection of the upper rail 206 and second stile 204 of the exterior side 2 of the sliding panel 14. The second stile 204 includes sealing members coupled to the second stile 204. For example, a first sealing member 236 is substantially airtight and watertight, which limits air and water from passing through the first sealing member 236 when the sliding panel 14 is in the closed position. The first sealing member 236 extends from the sliding panel 14 and engages with the fixed panel 16 when the sliding panel 14 is in the closed position. A first transition sealing member 237 (see FIG. 14B) and a second transition sealing member 238 (see FIG. 15) are also provided to limit air and water flow beyond the transition sealing members 237, 238 when the sliding panel 14 is in the closed position. The first transition sealing member 37 is coupled to the upper rail 206 and the second transition sealing member 238 is coupled to the lower rail 208 of the sliding panel 14 and is operable to engage with the fenestration frame 12 when the sliding panel 14 is in the closed position. The transition sealing members 237, 238 accordingly provide one of the boundaries of the fenestration frame ventilation cavity 50 when the sliding panel 14 is in the closed position.

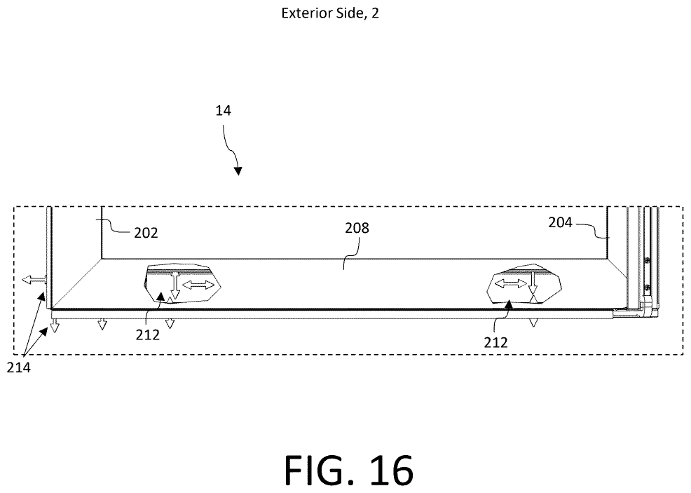

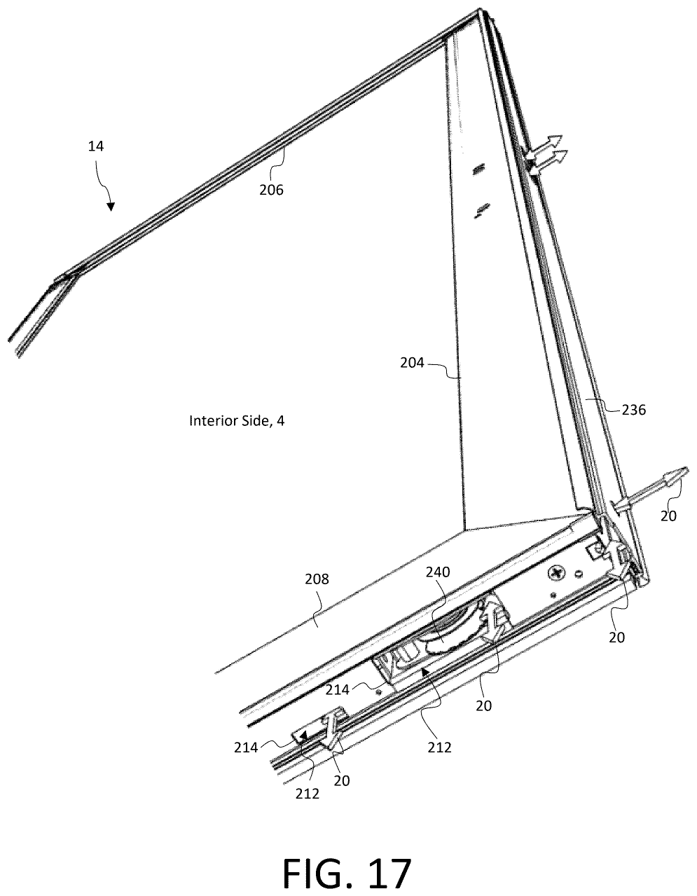

Referring to FIG. 16, the lower rail 208 of the sliding panel 14 is illustrated with cut-away portions for showing air flow within the sliding panel ventilation cavity 212. FIG. 17 shows air vents 214 on the lower rail 208. The air vents 214 can be provided for the purpose of facilitating air flow into the sliding panel ventilation cavity 212. Other air vents 214 may also be openings for other components, for example rollers 240, also described as guides 240, on which the sliding panel 14 rides when transitioning between open and closed positions. It is understood that the rollers 240 or other features facilitating sliding of the sliding panel 14 along the fenestration frame 12 may be on either the lower rail 208 or the upper rail 206 (e.g., barn door-type rollers). These various features may provide additional openings of air vents 214 into the sliding panel ventilation cavity 212. The air vents 214 may be apertures through the walls of the lower rail 208. As previously discussed, the air vents 214 provide fluid communication between the exterior side 2 of the fenestration unit 10, the sliding panel ventilation cavity 212, and the fenestration frame ventilation cavity 50.

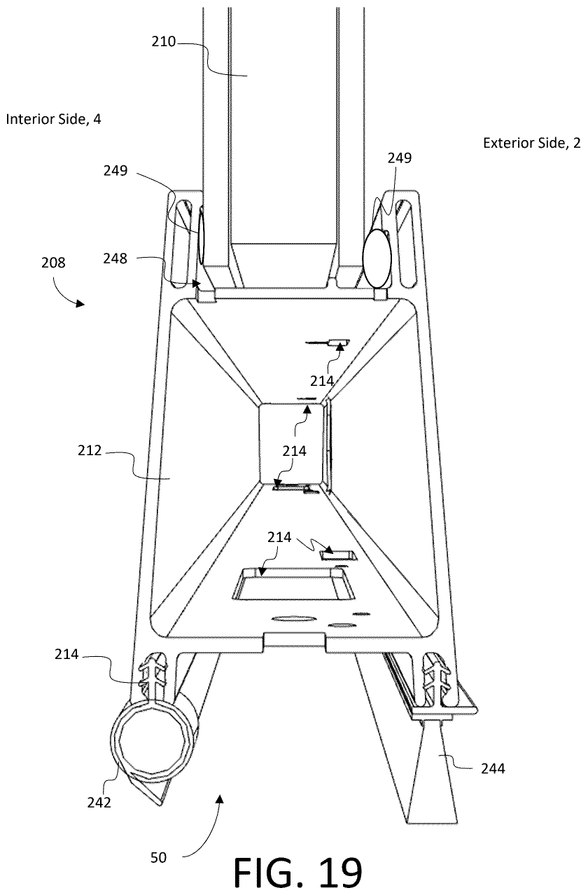

Referring now to FIGS. 18 and 19, the lower rail 208 of the sliding panel 14 is shown in a section view showing the sliding panel ventilation cavity 212. The lower rail 208 of the sliding panel 14 includes an interior seal 242 that is substantially watertight and airtight and an exterior seal 244 that is substantially watertight. The interior seal 242 and the exterior seal 244 extend from the lower rail 208 to engage the fenestration frame 12. The exterior seal 244 allows air to flow therethrough to limit a pressure differential with the exterior side 2 of the fenestration unit 10.

FIGS. 18 and 19 further depict the lower rail 208 defining a glazing cavity 248 operable to receive and support the glazing unit 210. Each of the first and second stiles 202, 204 and the upper and lower rails 206, 208 include a glazing cavity 248, but the glazing cavity 248 of the lower rail 208 is shown as an example of each. A portion of the glazing unit 210 is received within the glazing cavity 248. A bracket 250 may be provided within the glazing cavity 248 to position the glazing unit 210 toward the interior side 4 such that a seal is formed between the glazing unit 210 and the lower rail 208. The seal limits or prevents air and water from penetrating the sliding panel 14 from the exterior side 2 to the interior side 4 and the interior side 4 to the exterior side 2. In some embodiments, a sealing material 249 is applied to the interior and/or exterior side of the glazing cavity 248 to further limit or prevent air and water from penetrating the sliding panel 14 from the exterior side 2 to the interior side 4 and the interior side 4 to the exterior side 2 and to further control heat transfer. An air vent 214 is positioned from the ventilation cavity 212 into the glazing cavity 248. This facilitates pressure equalization of the glazing cavity 248 to the exterior side 2 of the fenestration unit 10, reducing the likelihood of water ingress across the seal between the glazing unit 210 and the sliding panel frame 200.

In terms of operation, by allowing exterior air pressure into the sliding panel ventilation cavity 212 and the fenestration frame ventilation cavity 50 and then permitting that air pressure to access the gaps between the various seals, the other sources of ventilation of exterior pressure provide a sink, or additional source of air to make the pressure equalization more responsive than if the equalization were occurring across the exterior seal 244 alone. This helps avoid a pressure gradient between the exterior 2 and the space between the interior and exterior seals 242, 244 which might otherwise encourage water into that space and against the interior seal 242 and/or into the glazing cavity. Referring to FIG. 19, a plurality of air vents 214 are defined through the lower rail 208.

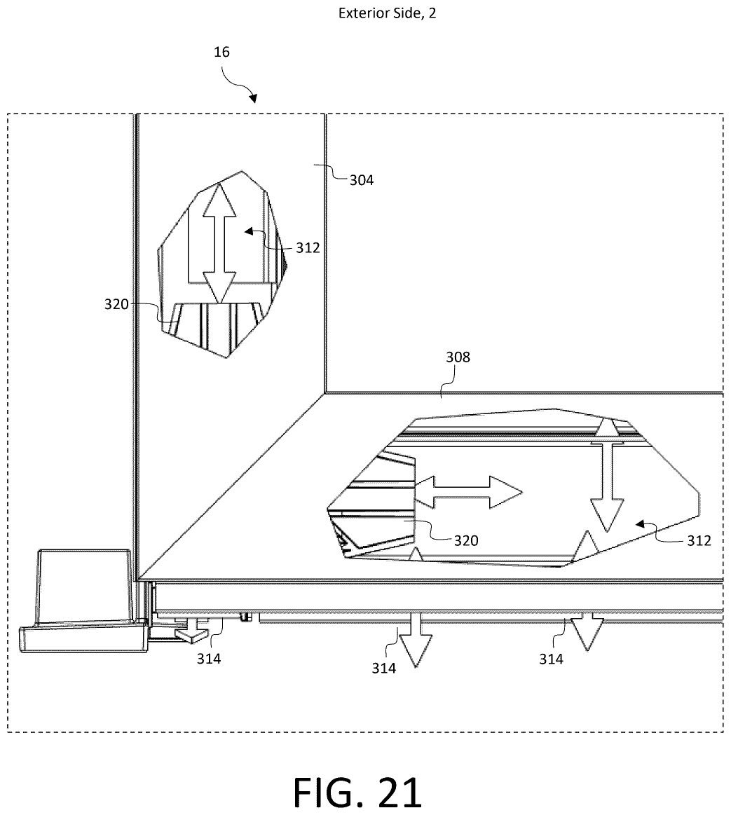

Turning now to a discussion of the fixed panel 16, FIGS. 20-23 illustrate the fixed panel 16 with a plurality of air vents 314 in fluid communication with a fixed panel ventilation cavity 312 and the fenestration frame ventilation cavity 50. For example, FIG. 20 shows air vents 314 defined in the upper and lower rails 306, 308 and the second stile 304. Similar to the discussion of the corner lock members 220 of the sliding panel 14, the fixed panel 16 may also include corner lock members 320 (shown in FIG. 21) that are operable to allow air to flow between the stiles 302, 304 and the rails 306, 308 of the fixed panel 16.

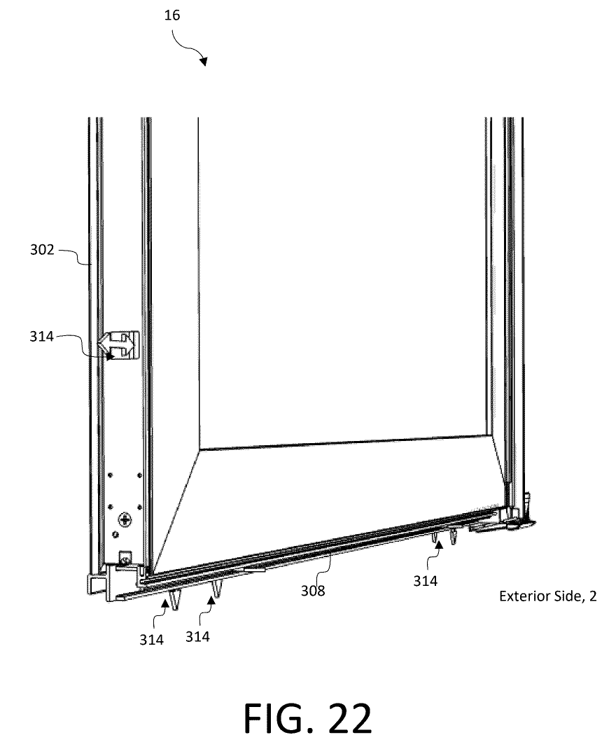

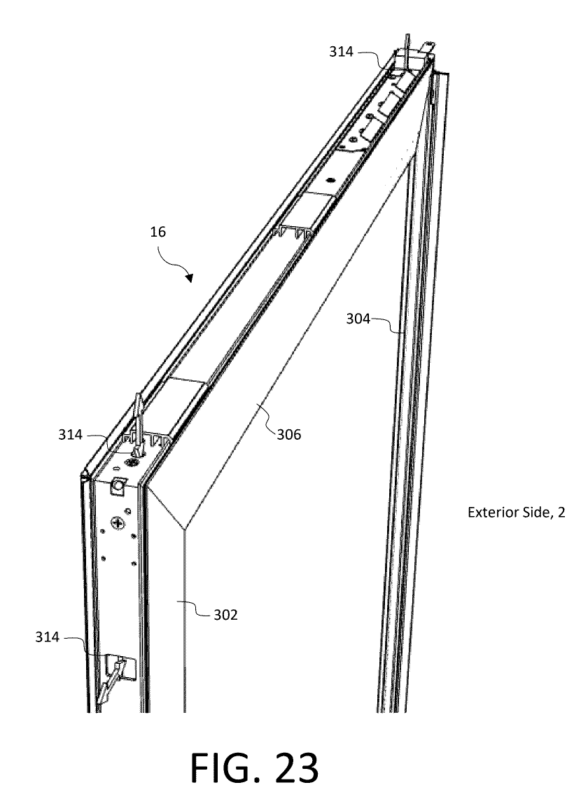

Referring to FIGS. 22 and 23, the air vents 314 are shown in more detail and may be positioned along the fixed panel 16 at various positions. For example, air vents 314 may be positioned adjacent to the intersection of the lower rail 304 and the first stile 302 on either the lower rail 304, the first stile 302, or both (see FIG. 22) and/or adjacent to the intersection of the upper rail 306 and the first stile 302 on either the upper rail 306, the first stile 302, or both (see FIG. 23). Air vents 314 may also be defined at other positions along the length of the upper or lower rails 306, 308, for example adjacent the second stile 304.

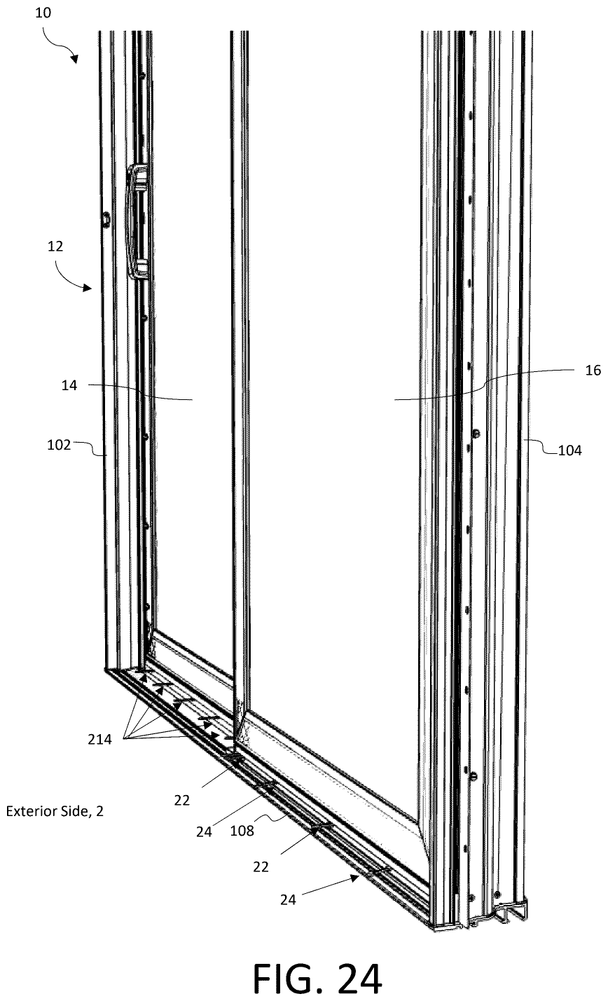

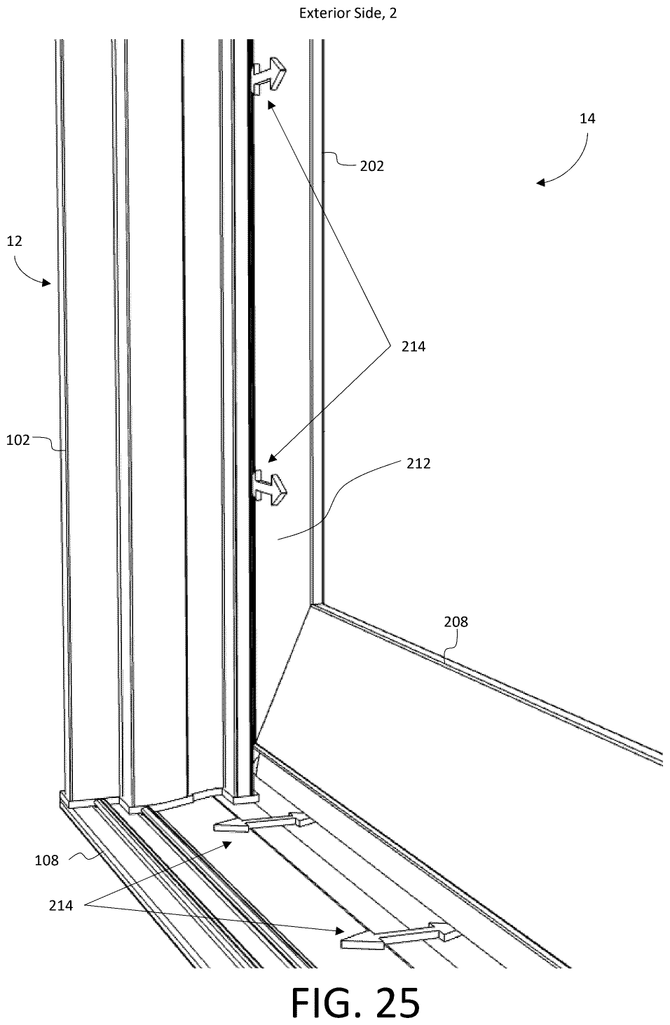

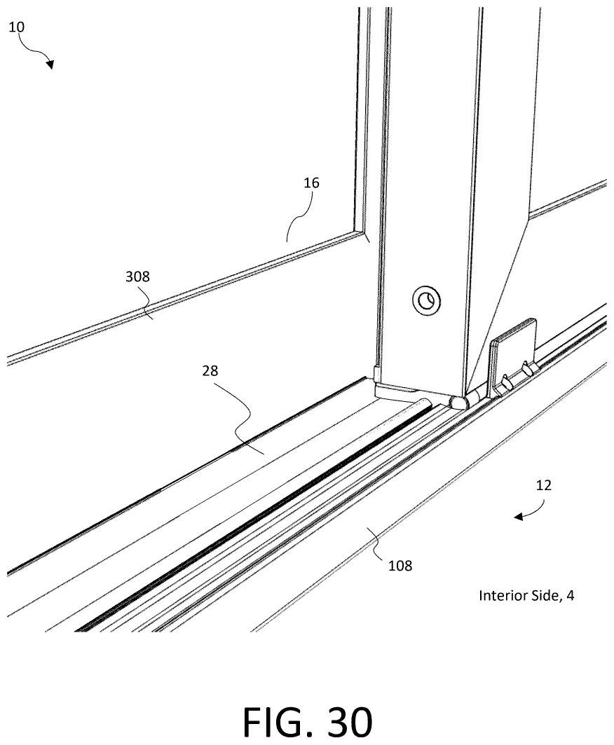

Referring to FIGS. 24-30 illustrate the fixed panel 16 and/or the sliding panel 14 positioned with the fenestration frame 12. FIG. 24 illustrates different positions at which air is able to enter the fenestration frame ventilation cavity 50 and the ventilation cavities 212, 312 of the sliding and fixed panels 14, 16, respectively. FIG. 25 shows a closer view of the sliding panel 14 and the fenestration frame 12. Air can travel through to the fenestration frame ventilation cavity 50 and the sliding panel ventilation cavity 212 between the fenestration frame 12 and the lower rail 208 and the first stile 202 (but is not able to pass through to the interior side of the fenestration unit 10 as previously discussed).

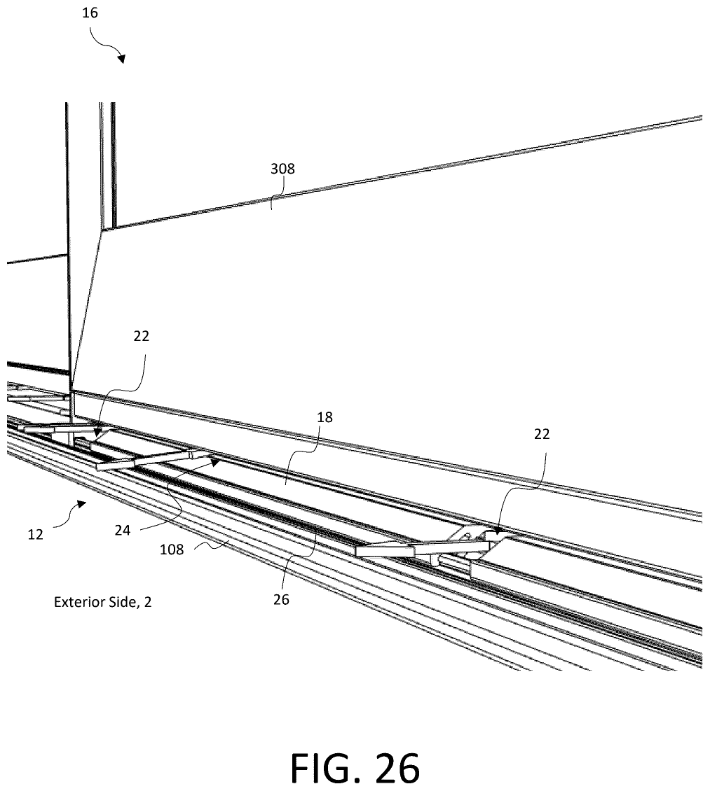

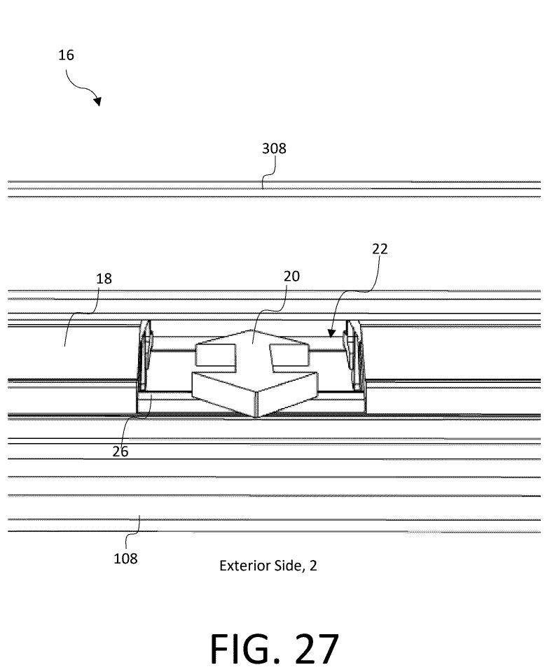

FIG. 26 illustrates the fixed panel 16 positioned with the fenestration frame 12. The fenestration frame 12 is shown with a lower sill 18 that includes a plurality of channels 22 formed to allow air to flow through to the fenestration frame ventilation cavity 50 and the fixed panel ventilation cavity 312. The fixed panel 16 may also be positioned such that a gap 24 is present between the lower rail 308 of the fixed panel 16 and the lower sill 18 of the fenestration frame 12 on the exterior side 2 such that air can flow through the gap 24 to the fixed frame ventilation cavity 312. The gap 24 and the channels 22 are positioned to allow air flow between the exterior side 2 of the fenestration unit 10 and the fixed panel ventilation cavity 312 and fenestration frame ventilation cavity 50 (e.g., the space between the fixed panel 16 and the sill 18 of the fenestration frame 12). The fixed panel 16 further includes some air vents 314 to allow air flow between the fixed panel ventilation cavity 312 and the fenestration frame ventilation cavity 50 (e.g., the space 26 between the fixed panel 16 and the second jamb 104 of the fenestration frame 12) (see FIG. 20). Referring to FIG. 27, the channels 22 of the sill 18 are shown in more detail. The channels 22 may be positioned such that any water that enters around the perimeter of the fixed panel 16 may flow through the channels 22 out to the exterior side 2 and away from the fixed panel 16 (e.g., the channels 22 may include a downward slope from the interior side 4 to the exterior side 2).

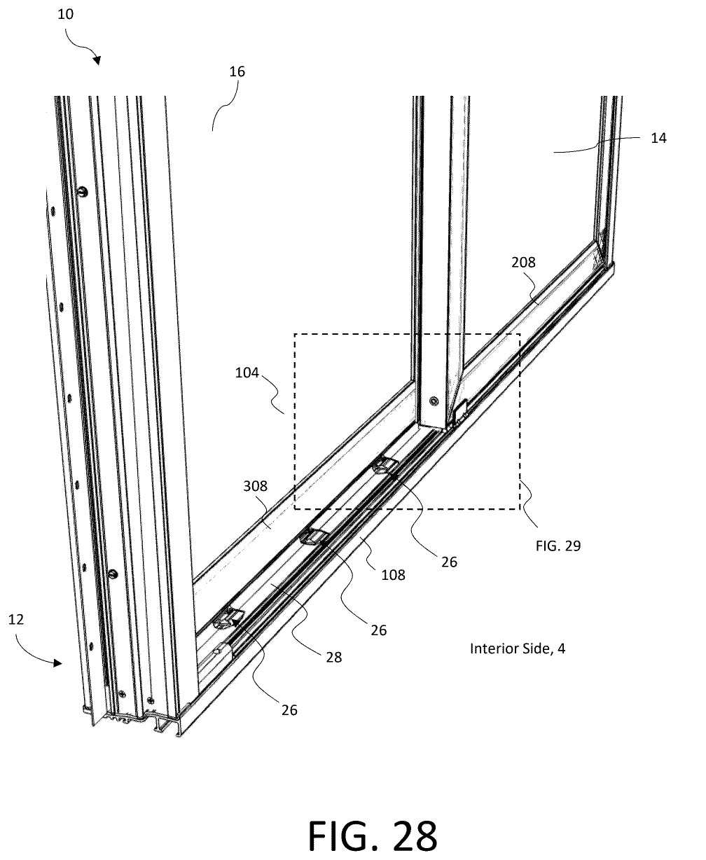

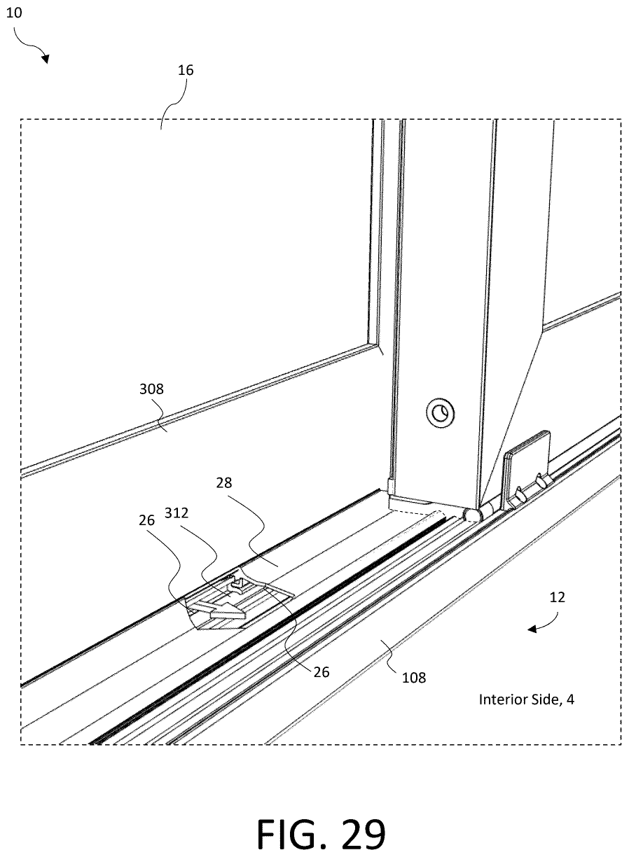

FIG. 28 illustrates the fenestration unit 10 on the interior side 4. The fenestration unit 10 includes a fixed cover 28 (see FIGS. 28-30). The fixed cover 28 defines a boundary of a portion of the fenestration frame ventilation cavity 50 (e.g., space 26) through which air flows from the gap 24 or channels 22. The fixed cover 28 is coupled to the fenestration frame 12 on the interior side 4 of the fenestration unit 10 and may form at least a portion of the interior seal. The fixed cover 28 provides a substantially airtight and watertight seal with the fixed panel 16 and the fenestration frame 12. The vents 314, the channels 22, and the gap 24 is positioned to allow air flow between the exterior side 2 of the fenestration unit 10 and the space 26 between the fixed cover 28 and the sill 18 of the fenestration frame 12. FIGS. 28 and 29 illustrate a cutaway portion of the fixed cover 28 with cutouts to show the space 26 that is formed at least partially beneath the fixed cover 28 which allows airflow from the exterior side 2 of the fenestration unit 10 and the fixed panel ventilation cavity 312.

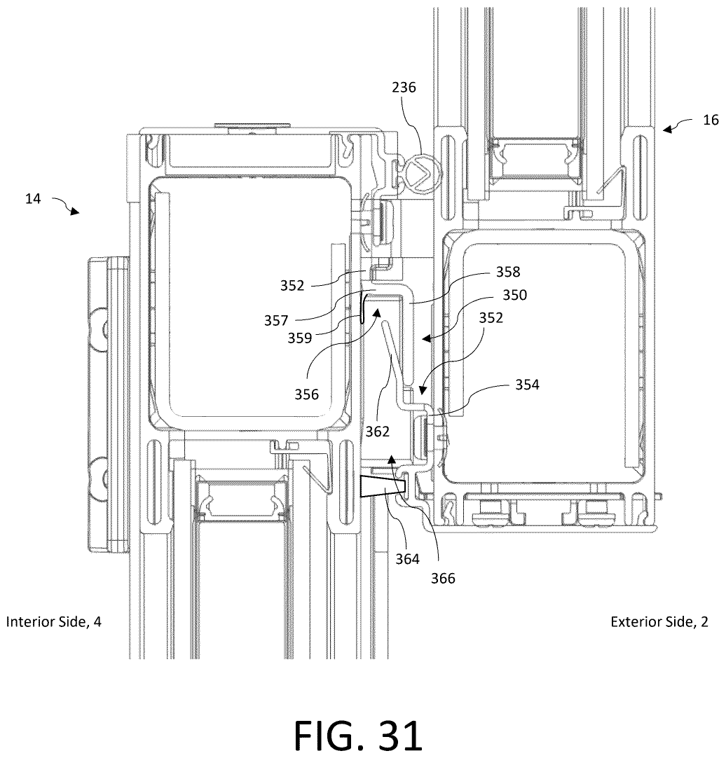

Referring to FIG. 31, a cross section of the interface between the sliding panel 14 and the fixed panel 16 is illustrated, with the sliding panel 14 being in the closed configuration. An interlocker 350 is provided that facilitates closing and sealing of the sliding panel 14 when in the closed configuration. For example, the interlocker 350 includes a sliding panel portion 352 and a fixed panel portion 354. The sliding panel portion 352 extends from the sliding panel 14 (e.g., the second stile 204). The sliding panel portion 352 defines an engagement feature 356 (e.g., a lip) with a first portion 357 that extends away from the sliding panel 14 and then a second portion 358 that extends substantially parallel to the sliding panel 14. The sliding panel portion 352 includes a seal 359 that limits water and air ingress between the sliding panel portion 352 and the sliding panel 14. The fixed panel portion 354 of the interlocker 350 includes a complimentary engagement feature 360 (e.g., a lip) that is operable to engage with the engagement feature 356 of the sliding panel portion 352. The complimentary engagement feature 360 extends away from the fixed panel 16 and has an angled surface 362 which the second portion 358 pf the sliding panel portion 352 engages when the sliding panel 14 is being transitioned to the closed configuration. The sliding panel portion 352 and the fixed panel portion 354 engage with each other to position the sliding panel 14 and the fixed panel 16 in an appropriate position to create a water and air-tight seal between the two panels 14, 16 when in the closed position (e.g., via the sealing member 236). Because the interlocker has the angled surface 362, the sliding panel 14 is pulled in towards the fixed panel 16 to ensure engagement of the sealing member 236 between the two panels. The sliding panel portion 352 and the fixed panel portion 354 are positioned such that air is able to pass through the interface of the two components, thus allowing for equalization of pressure in the space between the sliding and fixed panels 14, 16. The space between the two panels 14, 16 can be pressure equalized through the interface of the sliding panel portion 352 and the fixed panel portion 354 as well as through the air vents 314 of the fixed panel 16. A second sealing member 364 is provided extending between the sliding panel 14 and the fixed panel 16 (e.g., from the fixed panel 16 toward the sliding panel 14). The second sealing member 364 is operable to limit water ingress through the second sealing member 364 while allowing airflow in to facilitate pressure equalization in the space 366 defined between the fixed panel 16 and the sliding panel 14 at the interlocker 350.

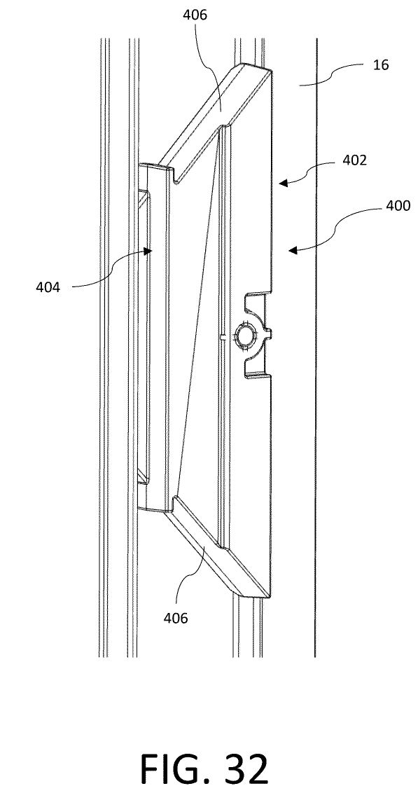

Referring to FIGS. 32-33, a spacer 400 is shown which is operable to position the fixed panel 16 relative to the fenestration frame 12. More specifically, the spacer 400 is positioned between the second stile 304 of the fixed panel frame 300 and the second jamb 104 of the fenestration frame 12. Referring more specifically to FIG. 32, the spacer 400 has an interior side 402 and an exterior side 404. The spacer 400 includes a tapered profile which is defined by sloped walls 406. The sloped walls 406 are positioned such that the sloped walls 406 extend substantially from the interior side 402 to the exterior side 404. The sloped walls 406 are oriented such that the tapered profile of the spacer 400 can be tapered to facilitate any water that is positioned between the fixed panel 16 and the fenestration frame 12 being directed towards the exterior side 2 side of the fenestration unit 10.

Although examples have been discussed throughout relating to a fenestration unit 10 with both a sliding panel 14 and a fixed panel 16, it is understood that the concepts and features discussed herein may be implemented in a variety of fenestration systems, including, but not limited to fixed panel units, hinged units, and so forth.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A fenestration unit having an exterior side and an interior side, the fenestration unit comprising:
a fenestration frame configured to be positioned within a fenestration of a structure, the fenestration frame including a first jamb, a second jamb, a header, and a sill;
a sliding panel operable to be slidably positioned with the fenestration frame, the sliding panel including a first stile, a second stile, an upper rail, and a lower rail defining a sliding panel frame, the sliding panel including a sliding panel ventilation cavity defined within the sliding panel frame and at least one air vent operable to provide fluid communication between the exterior side of the fenestration unit and the sliding panel ventilation cavity of the sliding panel frame;
a fixed panel operable to be fixedly positioned with the fenestration frame, the fixed panel including a first stile, a second stile, an upper rail, and a lower rail defining a fixed panel frame, the fixed panel including a fixed panel ventilation cavity defined within the fixed panel frame and at least one air vent operable to provide air flow between the exterior side of the fenestration unit and the fixed panel ventilation cavity of the fixed panel frame;
an interior seal positioned toward the interior side of the fenestration unit, the interior seal being substantially watertight and airtight when the fenestration unit is in a closed position; and
an exterior seal positioned toward the exterior side of the fenestration unit, the exterior seal being substantially watertight when the fenestration unit is in the closed position,
wherein the fenestration frame includes a fenestration frame ventilation cavity operable to receive air flow from the exterior side of the fenestration unit, the fenestration frame ventilation cavity defined at least partially between portions of the fenestration frame, the sliding panel and the fixed panel respectively, the interior seal, and the exterior seal.

2. The fenestration unit of claim 1, wherein the sliding panel includes a plurality of corner lock members operable to couple the upper rail and the lower rail to each of the first and second stiles, wherein the corner locks define passages through which air can flow between the first stile, the second stile, the upper rail, and the lower rail within the sliding panel ventilation cavity.

3. The fenestration unit of claim 1, wherein the sliding panel includes a first stile sealing member coupled to the first stile, the first stile sealing member including a first seal positioned on the exterior side of the fenestration unit and is substantially watertight when the sliding panel is in a closed position and a second seal positioned on an interior side of the fenestration unit and is substantially watertight and airtight when the sliding panel is in the closed position.

4. The fenestration unit of claim 1, wherein the first stile sealing member includes a body operable to support the first seal and the second seal, the first stile sealing member spanning the first stile between the interior side of the fenestration unit and the exterior side of the fenestration unit, the body being at least partially spaced from the first stile such that a gap is formed between the body and the first stile, the gap being in fluid communication with the sliding member ventilation cavity.

5. The fenestration unit of claim 1, wherein the sliding panel includes a second stile sealing member coupled to the second stile, the second stile sealing member including a first seal positioned between the first sliding panel and the fixed panel, the second stile sealing member being substantially watertight and airtight when the sliding panel is in a closed position.

6. The fenestration unit of claim 1, wherein the lower rail of the sliding panel includes at least one ventilation aperture allowing fluid communication between the sliding panel ventilation cavity and the fenestration frame ventilation cavity.

7. The fenestration unit of claim 1, wherein the fixed panel includes a plurality of vents operable to provide fluid communication between the fixed panel ventilation cavity and the fenestration frame ventilation cavity.

8. The fenestration unit of claim 1, wherein the fenestration frame ventilation cavity is operable to receive air from the exterior side of the fenestration unit through the exterior seal.

9. The fenestration unit of claim 1, wherein the fenestration frame ventilation cavity is in fluid communication with the sliding panel ventilation cavity and the fixed panel ventilation cavity.

10. The fenestration unit of claim 1, wherein the at least one vent is positioned to allow air flow between the fixed panel ventilation cavity and the fenestration frame ventilation cavity at a space between the fixed panel and the second jamb of the fenestration frame.

11. The fenestration unit of claim 1, wherein the at least one vent is positioned to allow air flow between the fixed panel ventilation cavity and the fenestration frame ventilation cavity at a space between the fixed panel and the header of the fenestration frame.

12. The fenestration unit of claim 1, wherein the at least one vent is positioned to allow air flow between the fixed panel ventilation cavity and the fenestration frame ventilation cavity at a space between the fixed panel and the sill of the fenestration frame.

13. The fenestration unit of claim 1, further comprising a fixed cover operable to be coupled to the fenestration frame on the interior side of the fenestration unit, the fixed cover forming a portion of the interior seal and providing a substantially airtight and watertight seal with the fixed panel and the fenestration frame.

14. The fenestration unit of claim 13, wherein the at least one vent is positioned to allow air flow between the exterior side of the fenestration unit and a space between the fixed cover and the sill of the fenestration frame

15. The fenestration unit of claim 1, wherein the at least one vent includes a downward slope from the interior side of the fenestration unit toward the exterior side of the fenestration unit.

16. The fenestration unit of claim 1, wherein the sliding panel and the fixed panel each include a respective glazing cavity, and wherein at least one of the fixed panel and the sliding panel includes at least one air vent providing fluid communication between the sliding panel ventilation cavity or the fixed panel ventilation cavity and the respective glazing cavity.

17. The fenestration unit of claim 1, wherein the at least one vent is positioned proximate three corners of the fixed panel and the fenestration frame ventilation cavity.

18. A fenestration unit for reducing moisture entry due to pressure differentials, the fenestration unit having an interior side and an exterior side, the fenestration unit comprising:
a sliding panel including a glazing unit and a sliding panel frame, the sliding panel frame including first stile, a second stile, an upper rail, and a lower rail, the sliding panel frame defining a glazing cavity within which the glazing unit supported by the sliding panel frame, the sliding panel frame including a sliding panel ventilation cavity defined within the sliding panel frame, the sliding panel frame including at least one air vent operable to provide fluid communication between the sliding panel ventilation cavity and the glazing cavity; and
a fixed panel including a glazing unit and a fixed panel frame, the fixed panel frame including first stile, a second stile, an upper rail, and a lower rail, the fixed panel frame defining a glazing cavity within which the glazing unit supported by the fixed panel frame, the fixed panel frame including a fixed panel ventilation cavity defined within the fixed panel frame, the fixed panel frame including at least one air vent operable to provide fluid communication between the fixed panel ventilation cavity and the glazing cavity.

19. A panel for a fenestration unit for reducing moisture entry due to pressure differentials, the panel having an interior side and an exterior side, the panel comprising:
a panel frame including a first stile, a second stile, an upper rail, a lower rail, and a plurality of corner lock members operable to couple the upper rail and the lower rail to each of the first and second stiles, the panel frame defining a ventilation cavity, wherein the corner locks define passages through which air can flow between the first stile, the second stile, the upper rail, and the lower rail within the ventilation cavity, the panel frame defining a glazing cavity;
a glazing unit supported by the sliding panel frame within the glazing cavity;
an interior seal operable to define a pressure differential; and
an exterior seal operable to shed water.

20. The panel of claim 19, wherein the panel frame includes at least one vent defined within at least one of the first stile, the second stile, the upper rail, and the lower rail, the at least one vent operable to allow fluid communication between the a glazing cavity and the ventilation cavity.
